(19) United States
(12) Patent Application Publication
(10) Pub. No.: US 2020/0047528 A1
(43) Pub. Date: Feb. 13, 2020

(54) PRINTING SYSTEM, WORK SUPPORT APPARATUS, AND METHOD

(71) Applicant: CANON KABUSHIKI KAISHA, Tokyo (JP)

(72) Inventors: Seiji Suzuki, Kawasaki-shi (JP); Takashi Horiba, Kawasaki-shi (JP); Masahito Yoshida, Shiki-shi (JP)

(21) Appl. No.: 16/531,188

(22) Filed: Aug. 5, 2019

(30) Foreign Application Priority Data
Aug. 7, 2018 (JP) 2018-148722
May 22, 2019 (JP) 2019-096251

(51) Int. Cl. B41J 25/304

(52) U.S. Cl. CPC B41J 25/304

(57) ABSTRACT

A printing system includes a printing apparatus that includes a printhead which discharges ink and a carriage which supports the printhead, a lifting unit configured to lift the printhead from the carriage, and a guide unit configured to guide the lifting unit to move in a horizontal direction.

### BACKGROUND OF THE INVENTION

### Field of the Invention

The present invention relates to a technique for replacing a printhead that discharges ink.

### Description of the Related Art

A technique of printing an image on a print medium by discharging an ink is proposed. For example, Japanese Patent Laid-Open No. 2003-182064 discloses an image forming apparatus configured to form an ink image on an intermediate member and transfer the ink image to a sheet. This apparatus includes an inkjet device that forms a primary image on the intermediate member. This apparatus also includes a zone where an aggregate is formed in the primary image, a zone where a liquid is partially removed from the aggregate, a zone where an image is transferred to a sheet, and a zone where the surface of the intermediate member is reproduced before a new primary image is formed. In addition, there is also known an apparatus that performs printing by discharging ink directly onto a print medium instead of an intermediate member.

A printhead that discharges ink needs to be replaced when the performance of the printhead degrades. The replacement operation of the printhead is not easy to perform in a comparatively large printing apparatus. As a technique for facilitating the replacement operation, Japanese Patent Laid-Open No. 2007-136762 discloses a mechanism for removing a line head housing by lowering the line head housing into a cradle and sliding the cradle outside the apparatus.

In general, a printhead is formed to be movable in a horizontal direction between a position for performing printing and a position for performing processing to recover the performance of the printhead, and the line head housing disclosed in Japanese Patent Laid-Open No. 2007-136762 is also arranged in a similar manner. In the technique disclosed in Japanese Patent Laid-Open No. 2007-136762, in addition to these positions, the line head housing needs to be moved further in the horizontal direction to a position for lowering the line head housing into the cradle, and this can increase the area occupied by the system.

### SUMMARY OF THE INVENTION

The present invention provides a technique that allows a printhead to be replaced while suppressing an increase in an area occupied by a system.

According to an aspect of the present invention, there is provided a printing system comprising: a printing apparatus that includes a printhead which discharges ink and a carriage which supports the printhead; a lifting unit configured to lift the printhead from the carriage; and a guide unit configured to guide the lifting unit to move in a horizontal direction.

Further features of the present invention will become apparent from the following description of exemplary embodiments (with reference to the attached drawings).

### BRIEF DESCRIPTION OF THE DRAWINGS

FIG. 1 is a schematic view showing a printing system;

FIG. 2 is a perspective view showing a print unit;

FIG. 3 is an explanatory view showing a displacement mode of the print unit in FIG. 2;

FIG. 4 is a block diagram showing a control system of the printing system in FIG. 1;

FIG. 5 is a block diagram showing the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8 is a schematic view showing a work support apparatus;

FIG. 9 is an explanatory view of the position of the work support apparatus;

FIG. 10 is a perspective view of the work support apparatus to which a printhead is connected;

FIG. 11 is a view in which the work support apparatus to which the printhead is connected is seen from an X direction;

FIG. 12 shows a perspective view of the work support apparatus illustrating a state in which a lifting unit has been expanded and an enlarged view of an angle lock member;

FIG. 13 is a perspective view of the work support apparatus to which a reinforcing member has been attached;

FIG. 14 is an explanatory view showing the structure of the reinforcing member of FIG. 13;

FIG. 15A is an explanatory view showing a pivot mode of the lifting unit;

FIG. 15B is an explanatory view showing another the pivot mode of the lifting unit;

FIG. 16 is an explanatory view of a lock unit;

FIG. 17A is an explanatory view of the movement of the lock unit of FIG. 16;

FIG. 17B is an explanatory view of the movement of the lock unit of FIG. 16;

FIG. 18 is a view showing a printhead replacement operation;

FIG. 19 is a view showing the printhead replacement operation;

FIG. 20 is a view showing the printhead replacement operation;

FIG. 21 is a view showing the printhead replacement operation;

FIG. 22 is a view showing the printhead replacement operation;

FIG. 23 is a view showing the printhead replacement operation;

FIG. 24 is a view showing the printhead replacement operation;

FIG. 25 is a view showing the printhead replacement operation;

FIG. 26 is a view showing the printhead replacement operation;

FIG. 27A is a view showing the printhead replacement operation;

FIG. 27B is a view showing the printhead replacement operation;

FIG. 27C is a view showing the printhead replacement operation;

FIG. 28A is a view showing the printhead replacement operation;

FIG. 28B is a view showing the printhead replacement operation;

FIG. 29 is an external perspective view of a structure;

FIG. 30 is a view showing the structure of FIG. 29 in a state in which a sliding door is at an open position;

FIG. 31 is a an external perspective view of the structure of FIG. 29 in which a top surface cover is at the open position;

FIG. 32 is an external view of the structure of FIG. 29 in a state in which the top surface cover is at the open position;

FIG. 33A is an external perspective view showing a frame portion of the structure of FIG. 29;

FIG. 33B is a partially enlarged view of FIG. 33A;

FIG. 34 is an explanatory view of the structure of FIG. 29 in a state in which the top surface cover is at a closed position:

FIG. 35 is an explanatory view of the structure of FIG. 29 in a state in which the top surface cover is at the open position and is locked;

FIG. 36 is an explanatory view of the structure of FIG. 29 in which the top surface cover is at the open position and is unlocked; and

FIG. 37 is a sectional perspective view showing a lock release lever mechanism.

### DESCRIPTION OF THE EMBODIMENTS

Embodiments of the present invention will be described with reference to the accompanying drawings. In each drawing, arrows X and Y indicate horizontal directions and intersect with each other (that is, they are perpendicular to each other in this case). An arrow Z indicates a vertical direction.

<Printing System>

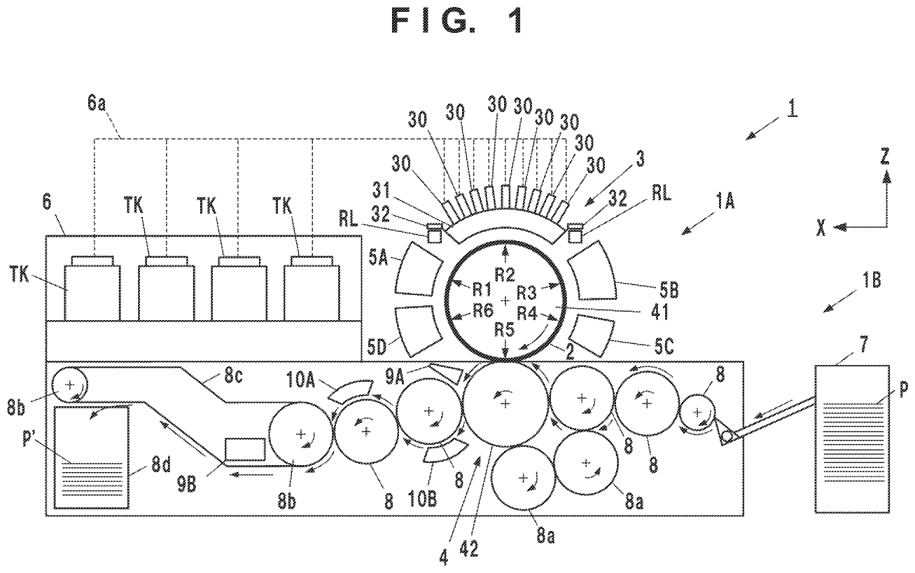

FIG. 1 is a front view schematically showing a printing system (printing apparatus) 1 according to an embodiment of the present invention. The printing system 1 is a sheet inkjet printer that forms (manufactures) a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

Note that “print” includes not only formation of significant information such as a character or graphic pattern but also formation of an image, design, or pattern on print media in a broader sense or processing of print media regardless of whether the information is significant or insignificant or has become obvious to allow human visual perception. In this embodiment, “print media” are assumed to be paper sheets but may be fabrics, plastic films, and the like.

An ink component is not particularly limited. In this embodiment, however, a case is assumed in which aqueous pigment ink that includes a pigment as a coloring material, water, and a resin is used.

<Printing Apparatus>

The printing apparatus 1A includes a print unit 3, a transfer unit 4, peripheral units 5A to 5D, and a supply unit 6.

<Print Unit>

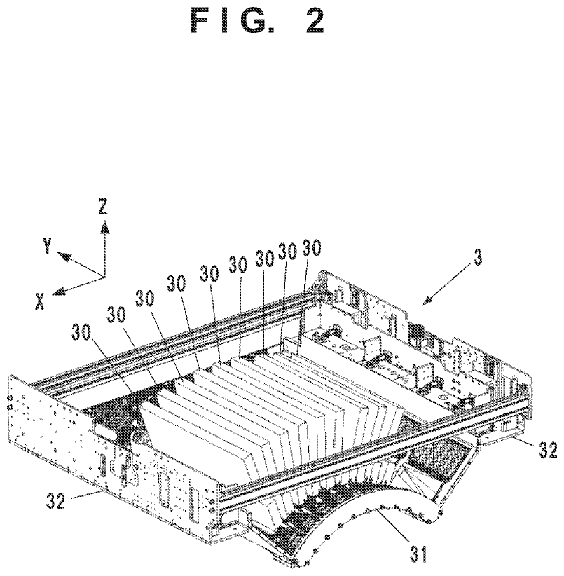

The print unit 3 includes a plurality of printheads 30 and a carriage 31. A description will be made with reference to FIGS. 1 and 2. FIG. 2 is perspective view showing the print unit 3. The printheads 30 discharge liquid ink to the transfer member 2 and form ink images of a printed image on the transfer member 2.

In this embodiment, each printhead 30 is a full-line head elongated in the Y direction, and nozzles are arrayed in a range where they cover the width of an image printing area of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a well-known inkjet printer is applicable. For example, an element that discharges ink by causing film boiling in ink with an electrothermal transducer and forming a bubble, an element that discharges ink by an electromechanical transducer (piezoelectric element), an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink. However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide member RL. In this embodiment, the guide members RL are rail members elongated in the Y direction and provided as a pair separately in the X direction. A slide portion 32 is provided on each side of the carriage 31 in the X direction. The slide portions 32 engage with the guide members RL and slide along the guide members RL in the Y direction.

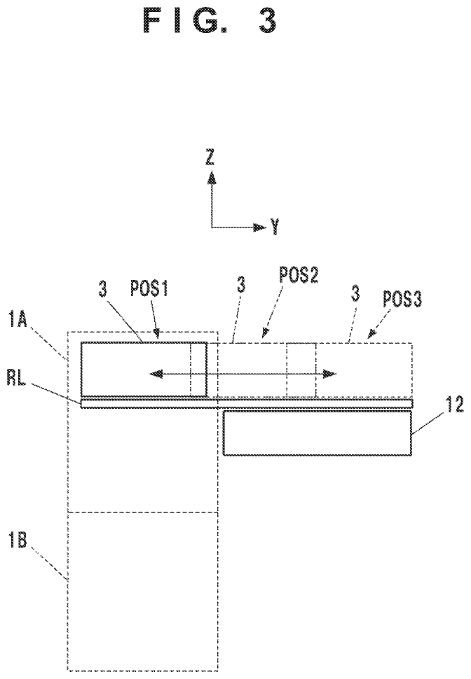

FIG. 3 is a view showing a displacement mode of the print unit 3 and schematically shows the right side surface of the printing system 1. A recovery unit 12 is provided in the rear of the printing system 1. The recovery unit 12 has a mechanism for recovering discharge performance of the printheads 30. For example, a cap mechanism which caps the ink discharge surface of each printhead 30, a wiper mechanism which wipes the ink discharge surface, a suction mechanism which sucks ink in the printhead 30 by a negative pressure from the ink discharge surface can be given as such mechanisms.

The guide member RL is elongated over the recovery unit 12 from the side of the transfer member 2. By the guide of the guide member RL, the print unit 3 is displaceable between a discharge position POS1 at which the print unit 3 is indicated by a solid line and a recovery position POS3 at which the print unit 3 is indicated by a broken line, and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is positioned above the recovery unit 12. The recovery unit 12 can perform recovery processing on the printheads 30 when the print unit 3 is positioned at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

<Transfer Unit>

The transfer unit 4 will be described with reference to FIG. 1. The transfer unit 4 includes a transfer drum (transfer cylinder) 41 and a pressurizing drum 42. Each of these drums is a rotating body that rotates about a rotation axis in the Y direction and has a columnar outer peripheral surface. In FIG. 1, arrows shown in respective views of the transfer drum 41 and the pressurizing drum 42 indicate their rotation directions. The transfer drum 41 rotates clockwise, and the pressurizing drum 42 rotates anticlockwise.

The transfer drum 41 is a support member that supports the transfer member 2 on its outer peripheral surface. The transfer member 2 is provided on the outer peripheral surface of the transfer drum 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer drum 41.

The transfer member 2 moves cyclically on the circular orbit by rotating the transfer drum 41. By the rotational phase of the transfer drum 41, the position of the transfer member 2 can be discriminated into a processing area R1 before discharge, a discharge area R2, processing areas R3 and R4 after discharge, a transfer area R5, and a processing area R6 after transfer. The transfer member 2 passes through these areas cyclically.

The processing area R1 before discharge is an area where preprocessing is performed on the transfer member 2 before the print unit 3 discharges ink and an area where the peripheral unit 5A performs processing. In this embodiment, a reactive liquid is applied. The discharge area R2 is a formation area where the print unit 3 forms an ink image by discharging ink to the transfer member 2. The processing areas R3 and R4 after discharge are processing areas where processing is performed on the ink image after ink discharge. The processing area R3 after discharge is an area where the peripheral unit 5B performs processing, and the processing area R4 after discharge is an area where the peripheral unit 5C performs processing. The transfer area R5 is an area where the transfer unit 4 transfers the ink image on the transfer member 2 to the print medium P. The processing area R6 after transfer is an area where post processing is performed on the transfer member 2 after transfer and an area where the peripheral unit 5D performs processing.

In this embodiment, the discharge area R2 is an area with a predetermined section. The other areas R1 and R3 to R6 have narrower sections than the discharge area R2. Comparing to the face of a clock, in this embodiment, the processing area R1 before discharge is positioned at almost 10 o'clock, the discharge area R2 is in a range from almost 11 o'clock to 1 o'clock, the processing area R3 after discharge is positioned at almost 2 o'clock, and the processing area R4 after discharge is positioned at almost 4 o'clock. The transfer area R5 is positioned at almost 6 o'clock, and the processing area R6 after transfer is an area at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide any desired surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used, or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl silicone rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small compression set. They are also advantageous in terms of transferability because of their small elasticity change by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modulus in order to suppress elongation in a horizontal direction or maintain resilience when attached to the transfer drum 41. Woven fabric may be used as a reinforce layer. The transfer member 2 can be manufactured by combining the respective layers formed by the materials described above in any desired manner.

The outer peripheral surface of the pressurizing drum 42 is pressed against the transfer member 2. At least one grip mechanism which grips the leading edge portion of the print medium P is provided on the outer peripheral surface of the pressurizing drum 42. A plurality of grip mechanisms may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42.

The transfer drum 41 and the pressurizing drum 42 can share a driving source such as a motor that drives them, and a driving force can be delivered by a transmission mechanism such as a gear mechanism.

<Peripheral Unit>

The peripheral units 5A to 5D are arranged around the transfer drum 41. In this embodiment, the peripheral units 5A to 5D are specifically an application unit, an absorption unit, a heating unit, and a cleaning unit in order.

The application unit 5A is a mechanism which applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism which applies the reactive liquid. If the reactive liquid is applied to the transfer member 2 before the ink is discharged to the transfer member 2, it is possible to immediately fix ink that reaches the transfer member 2. This makes it possible to suppress bleeding caused by mixing adjacent inks.

The absorption unit 5B is a mechanism which absorbs a liquid component from the ink image on the transfer member 2 before transfer. It is possible to suppress, for example, a blur of an image printed on the print medium P by decreasing the liquid component of the ink image. Describing a decrease in liquid component from another point of view, it is also possible to represent it as condensing ink that forms the ink image on the transfer member 2. Condensing the ink means increasing the content of a solid content such as a coloring material or a resin included in the ink with respect to the liquid component by decreasing the liquid component included in the ink.

The absorption unit 5B includes, for example, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5C is a mechanism which heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5C can use a known heating device, for example, various lamps such as infrared rays, a warm air fan, or the like. An infrared heater can be used in terms of heating efficiency.

The cleaning unit 5D is a mechanism which cleans the transfer member 2 after transfer. The cleaning unit 5D removes ink remaining on the transfer member 2, dust on the transfer member 2, or the like. The cleaning unit 5D can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the absorption unit 5B, the heating unit 5C, and the cleaning unit 5D are included as the peripheral units. However, cooling functions of the transfer member 2 may be applied, or cooling units may be added to these units. In this embodiment, the temperature of the transfer member 2 may be increased by heat of the heating unit 5C. If the ink image exceeds the boiling point of water as a prime solvent of ink after the print unit 3 discharges ink to the transfer member 2, performance of liquid component absorption by the absorption unit 5B may be degraded. It is possible to maintain the performance of liquid component absorption by cooling the transfer member 2 such that the temperature of the discharged ink is maintained below the boiling point of water.

The cooling unit may be an air blowing mechanism which blows air to the transfer member 2, or a mechanism which brings a member (for example, a roller) into contact with the transfer member 2 and cools this member by air-cooling or water-cooling. The cooling unit may be a mechanism which cools the cleaning member of the cleaning unit 5D. A cooling timing may be a period before application of the reactive liquid after transfer.

<Supply Unit>

The supply unit 6 is a mechanism which supplies ink to each printhead 30 of the print unit 3. The supply unit 6 may be provided on the rear side of the printing system 1. The supply unit 6 includes a reservoir TK that reserves ink for each kind of ink. Each reservoir TK may be made of a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink. A deaerating mechanism which deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is positioned lower than the ink discharge surface of the printhead 30.

<Conveyance Apparatus>

The conveyance apparatus 1B is an apparatus that feeds the print medium P to the transfer unit 4 and discharges, from the transfer unit 4, the printed product P′ to which the ink image was transferred. The conveyance apparatus 1B includes a feeding unit 7, a plurality of conveyance drums 8 and 8a, two sprockets 8b, a chain 8c, and a collection unit 8d. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism which feeds the print media P one by one from the stacking unit to the most upstream conveyance drum 8. Each of the conveyance drums 8 and 8a is a rotating body that rotates about the rotation axis in the Y direction and has a columnar outer peripheral surface. At least one grip mechanism which grips the leading edge portion of the print medium P (printed product P′) is provided on the outer peripheral surface of each of the conveyance drums 8 and 8a. A gripping operation and release operation of each grip mechanism may be controlled such that the print medium P is transferred between the adjacent conveyance drums.

The two conveyance drums 8a are used to reverse the print medium P. When the print medium P undergoes double-side printing, it is not transferred to the conveyance drum 8 adjacent on the downstream side but transferred to the conveyance drums 8a from the pressurizing drum 42 after transfer onto the surface. The print medium P is reversed via the two conveyance drums 8a and transferred to the pressurizing drum 42 again via the conveyance drums 8 on the upstream side of the pressurizing drum 42. Consequently, the reverse surface of the print medium P faces the transfer drum 41, transferring the ink image to the reverse surface.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 8 positioned at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

<Post Processing Unit>

The conveyance apparatus 1B includes post processing units 10A and 10B. The post processing units 10A and 10B are mechanisms which are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. The contents of the post processing includes, for example, coating that aims at protection, glossy, and the like of an image on the image printed surface of the printed product P′. For example, liquid application, sheet welding, lamination, and the like can be given as an example of coating.

<Inspection Unit>

The conveyance apparatus 1B includes inspection units 9A and 9B. The inspection units 9A and 9B are mechanisms which are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a temporal change in tint or the like of the printed image and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily suspending the run of the chain 8c. The inspection unit 9B may be a scanner that scans the printed product P′.

<Control Unit>

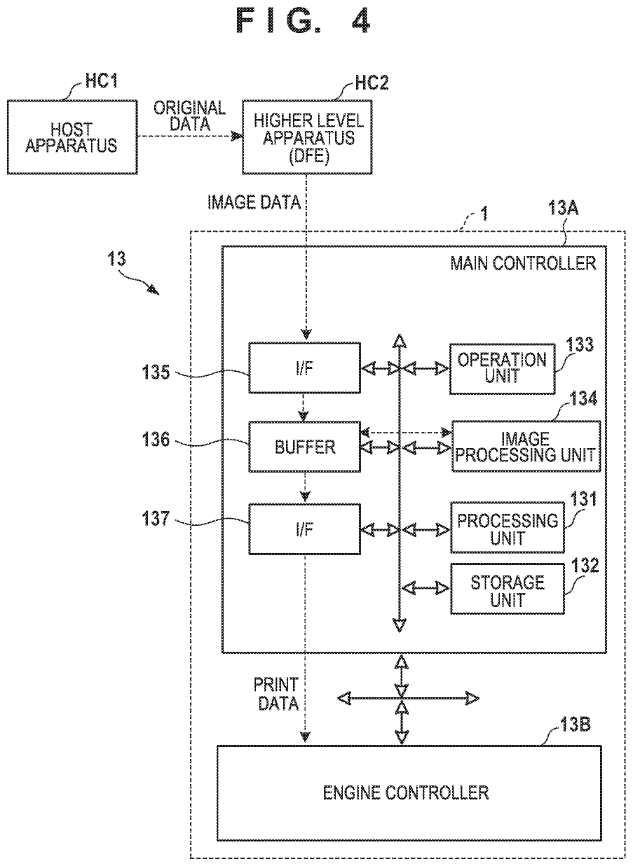

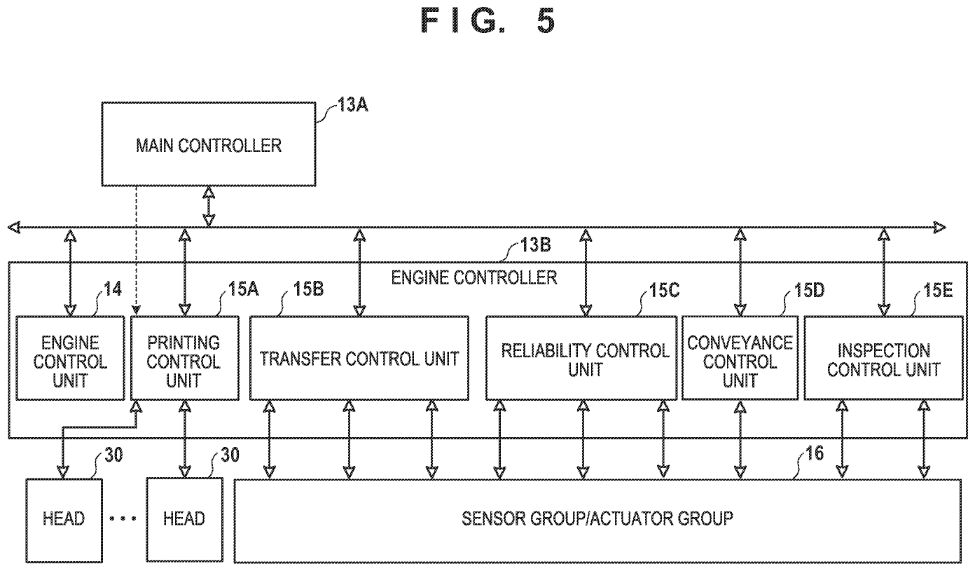

A control unit of the printing system 1 will be described next. FIGS. 4 and 5 are block diagrams each showing a control unit 13 of the printing system 1. The control unit 13 is communicably connected to a higher level apparatus (DFE) HC2, and the higher level apparatus HC2 is communicably connected to a host apparatus HC1.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) available by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the processing unit (CPU) 131, and provides the processing unit (CPU) 131 with a work area. The operation unit 133 is, for example, an input device such as a touch panel, a keyboard, or a mouse and accepts a user instruction.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes control units 14 and 15A to 15E, and obtains a detection result of a sensor group/actuator group 16 of the printing system 1 and controls driving of the groups. Each of these control units includes a processor such as a CPU, a storage device such as a RAM or a ROM, and an interface with an external device. Note that the division of the control units is merely illustrative, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the absorption unit 5B, the heating unit 5C, and the cleaning unit 5D.

The reliability control unit 15C controls the supply unit 6, the recovery unit 12, and a driving mechanism which moves the print unit 3 between the discharge position POS1 and the recovery position POS3.

The conveyance control unit 15D controls driving of the transfer unit 4 and controls the conveyance apparatus 1B. The inspection control unit 15E controls the inspection unit 9B and the inspection unit 9A.

Of the sensor group/actuator group 16, the sensor group includes a sensor that detects the position and speed of a movable part, a sensor that detects a temperature, an image sensor, and the like. The actuator group includes a motor, an electromagnetic solenoid, an electromagnetic valve, and the like.

<Operation Example>

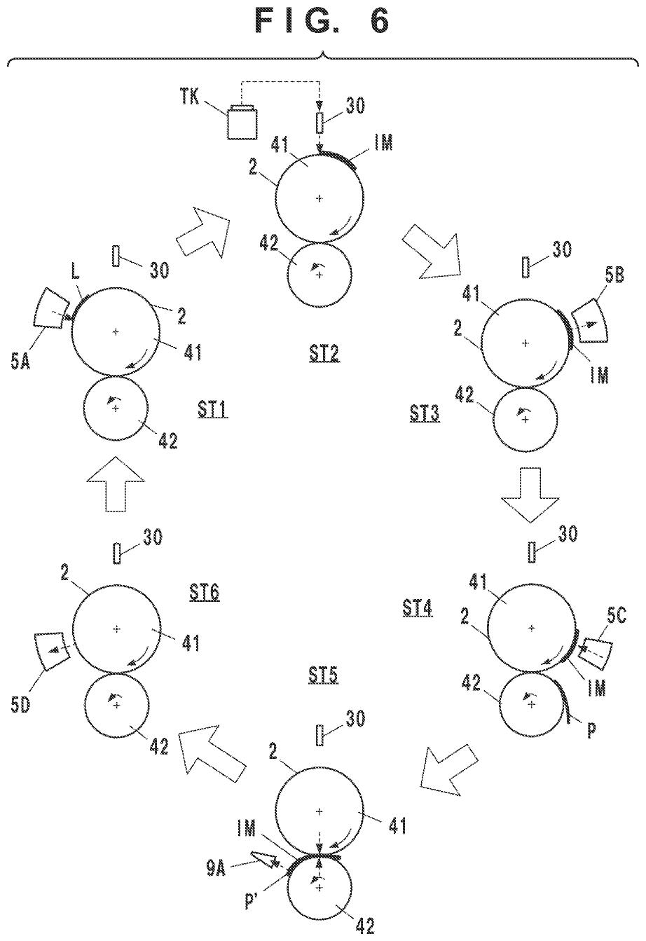

FIG. 6 is a view schematically showing an example of a printing operation. Respective steps below are performed cyclically while rotating the transfer drum 41 and the pressurizing drum 42. As shown in a state ST1, first, a reactive liquid L is applied from the application unit 5A onto the transfer member 2. A portion to which the reactive liquid L on the transfer member 2 is applied moves along with the rotation of the transfer drum 41. When the portion to which the reactive liquid L is applied reaches under the printhead 30, ink is discharged from the printhead 30 to the transfer member 2 as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the absorption unit 5B, as shown in a state ST3, the absorption unit 5B absorbs a liquid component from the ink image IM. When the ink image IM reaches the heating unit 5C, as shown in a state ST4, the heating unit 5C heats the ink image IM, a resin in the ink image IM melts, and a film of the ink image IM is formed. In synchronism with such formation of the ink image IM, the conveyance apparatus 1B conveys the print medium P.

As shown in a state ST5, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion where the ink image IM on the transfer member 2 is formed reaches the cleaning unit 5D, it is cleaned by the cleaning unit 5D as shown in a state ST6. After the cleaning, the transfer member 2 rotates once, and transfer of the ink image to the print medium P is performed repeatedly in the same procedure. The description above has been given such that transfer of the ink image IM to one print medium P is performed once in one rotation of the transfer member 2 for the sake of easy understanding. It is possible, however, to continuously perform transfer of the ink image IM to the plurality of print media P in one rotation of the transfer member 2.

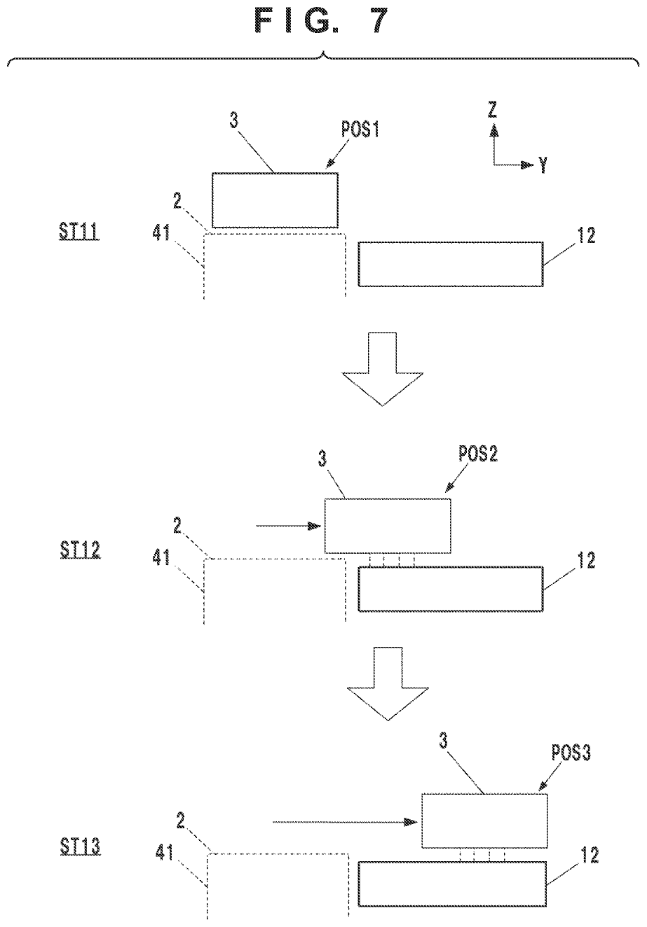

Each printhead 30 needs maintenance if such a printing operation continues. FIG. 7 shows an operation example at the time of maintenance of each printhead 30. A state ST11 shows a state in which the print unit 3 is positioned at the discharge position POS1. A state ST12 shows a state in which the print unit 3 passes through the preliminary recovery position POS2. Under passage, the recovery unit 12 performs a process of recovering discharge performance of each printhead 30 of the print unit 3. Subsequently, as shown in a state ST13, the recovery unit 12 performs the process of recovering the discharge performance of each printhead 30 in a state in which the print unit 3 is positioned at the recovery position POS3.

<Printhead Replacement>

Each printhead 30 needs to be replaced when the performance of the printhead degrades. An example of the replacement operation of the printhead 30 will be described.

(Work Support Apparatus)

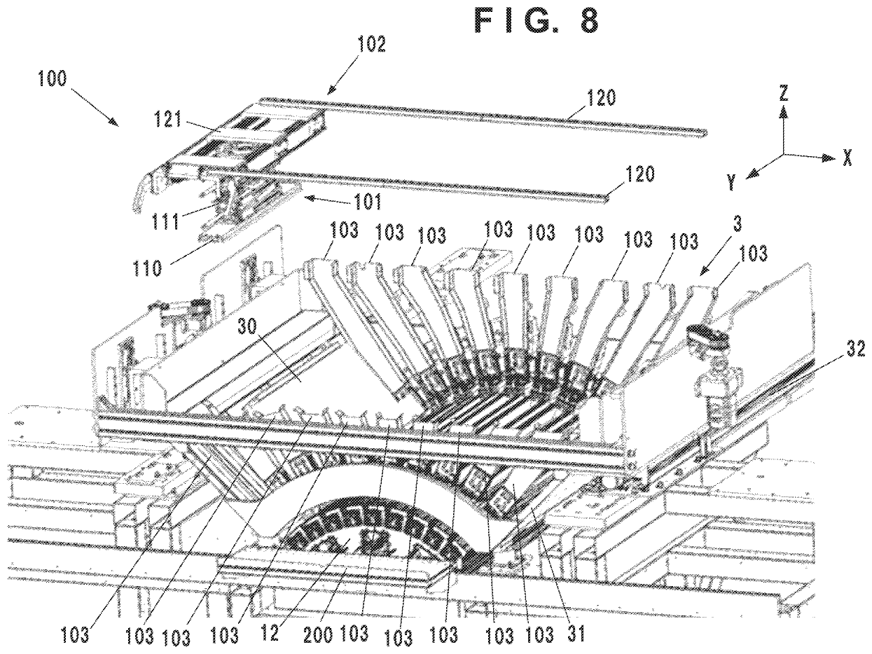

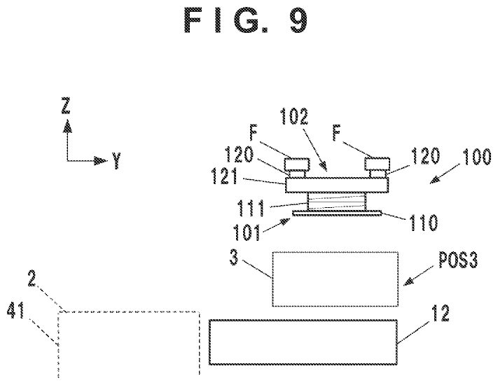

FIG. 8 is a schematic view of a work support apparatus 100 that supports the replacement operation of the printhead 30, and shows the surroundings of the print unit 3 positioned at the recovery position POS3. FIG. 9 is an explanatory view of the position of the work support apparatus 100 and shows a state in which the print unit 3 is positioned at the recovery position POS3.

In this embodiment, the work support apparatus 100 can be used to lift each printhead 30 from the carriage 31 from above and convey the printhead outside the printing apparatus 1A. In addition, the printhead 30 can be attached to the carriage 31 from above the carriage 31. Hence, it is possible to replace the printhead 30 while suppressing an increase in the area occupied by the printing system 1.

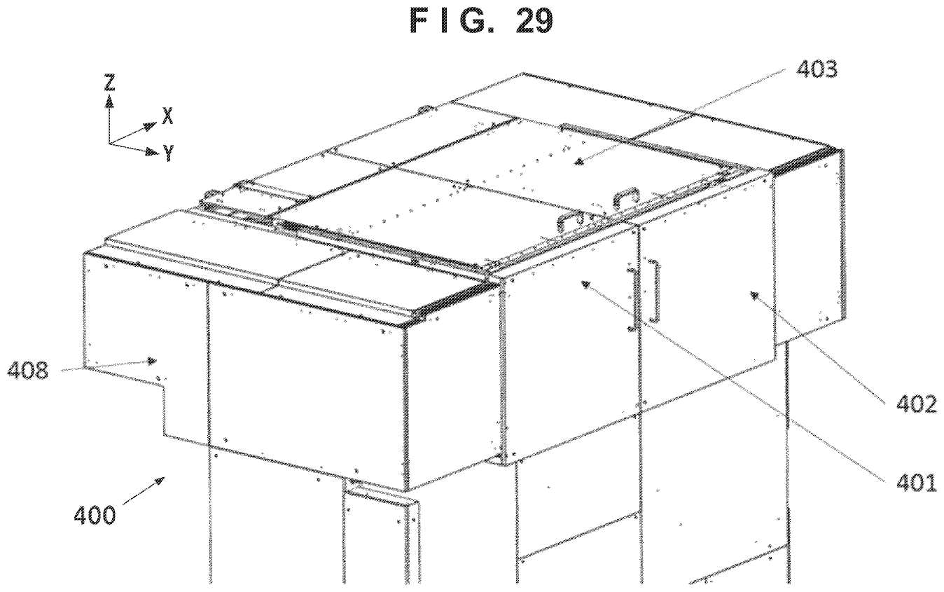

The work support apparatus 100 is supported so that is hung from frames F. The frames F are members which surround the periphery of the printing apparatus 1A, support external wall panels (not shown) or the like, and form a scaffold for an operator. An example of the structure surrounding the printing apparatus 1A will be described later with reference to FIGS. 29 to 37.

As shown in FIG. 9, the work support apparatus 100 is hung by the pair of the frames F such as beams extending in the X direction on the upper side of the recovery unit 12. That is, the work support apparatus 100 is arranged above the recovery position POS3 and can lift (detach) or lower (attach) each printhead 30 when the carriage 31 is positioned at the recovery position POS3. Since a dedicated space for the detachment/attachment of the printhead 30 is not needed because the printhead 30 can be detached from or attached to the carriage 31 at the recovery position POS3, it is possible to suppress the increase in the area occupied by the printing system 1. Also, since the printing apparatus 1A will be in a printing operation stopped state when the carriage 31 is positioned at the recovery position POS3, the replacement of the printhead 30 can be performed easily while the printing operation has been stopped. Also, although an ink discharge surface 301a may be unwantedly damaged when the printhead 30 is to be removed by sliding it in the horizontal direction, the risk of damage to the ink discharge surface 301a can be reduced because the printhead is lifted upwards and removed in this embodiment.

The work support apparatus 100 includes a lifting unit 101, a guide unit 102 that guides the movement of the lifting unit 101 in the horizontal direction, and guide members 103 which are attached to the carriage 31. Each guide member 103 is a member to guide the insertion and the removal of a corresponding one of the printheads 30 to the carriage 31, and is attached to the carriage 31 in the case of this embodiment. The guide members 103 may be attached constantly to the carriage 31 or may be detachable from the carriage 31 so that they can be attached to the carriage 31 when the replacement operation of the respective printheads 30 is to be performed.

The guide member 103 is arranged for each printhead 30, and particularly in this embodiment, two guide members are arranged for each printhead 30. The guide member 103 is arranged at each of the two ends of the attachment position of the corresponding printhead 30, and the guide member has a C-shaped sectional shape in the widthwise direction with an opening towards the inner side (the side of the printhead 30). Since the plurality of printheads 30 are arranged radially around the transfer drum (transfer cylinder) 41 which supports the transfer member 2, each guide member 103 is arranged tilted in correspondence with the tilt of the corresponding printhead 30.

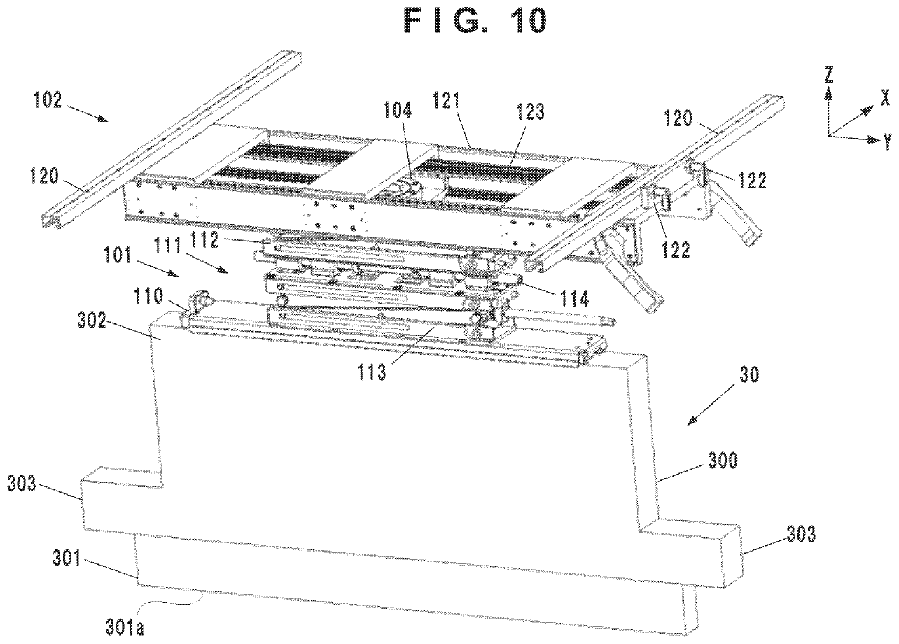

The arrangement of the lifting unit 101 and the guide unit 102 will be described with reference to FIGS. 10 and 11. FIG. 10 is a perspective view of the work support apparatus 100 showing a state in which the printhead 30 is held by the lifting unit 101, and FIG. 11 is a front view of the same seen in the X direction.

The printhead 30 is arranged to contain a circuit substrate and an ink liquid passageway in a housing 300. The printhead 30 includes one end portion 301 which includes the ink discharge surface 301a and the other end portion 302 which is positioned on the opposite side. The one end portion 301 is the lower portion and the other end portion 302 is the upper portion in a state in which the printhead 30 is attached to the carriage 31. The one end portion 301 and the other end portion 302 may be referred to as the lower portion 301 of the printhead 30 and the upper portion 302 of the printhead 30, respectively, and an upper portion 302—lower portion 301 direction may be referred to as the vertical direction of the printhead 30 hereinafter.

The ink discharge surface 301a can be referred to as the lower surface of the printhead 30. An array of nozzles that discharge ink is formed on the ink discharge surface 301a. The nozzle array direction is a D1 direction, and the D1 direction is the Y direction in a state in which the printhead 30 is attached to the carriage 31 in this case. A D2 direction is the ink discharge direction. The lower portion 301 and the upper portion 302 can be regarded as portions that opposite to each other in the ink discharge direction, and the ink discharge direction and the vertical direction of the printhead 30 are the same direction.

The printhead 30 includes engaging portions 303 that protrude outside in an ear-like manner on both ends in the D1 direction. Each engaging portion 303 engages with the corresponding guide member 103 and serves as the guided portion by which the insertion or the removal of the printhead 30 is guided.

The lifting unit 101 is an expanding and contracting mechanism to lift the printhead 30. The lifting unit 101 includes a connecting unit 110 and an expanding and contracting unit 111. The connecting unit 110 is a member used to connect the lifting unit 101 and the printhead 30 to each other, and the upper portion 302 of, particularly, the upper surface of the upper portion of the printhead 30 is fixed to the connecting unit 110 in the case of this embodiment. Although the fixing method is not particularly limited, it is possible to use, for example, bolted joints and screw holes may be provided in the housing 300 of the printhead 30 in this case.

The expanding and contracting unit 111 is arranged between the connecting unit 110 and the guide unit 102, and the upper portion of the expanding and contracting unit is connected to the guide unit 102 and the lower portion is connected to the connecting unit 110 in the case of this embodiment. In the case of this embodiment, the expanding and contracting unit 111 includes two expanding and contracting units, that is, an expanding and contracting unit 112 on the side of the guide unit 102 and an expanding and contracting unit 113 on the side of the connecting unit 110.

In the case of this embodiment, the expanding and contracting unit 112 is a pantograph jack and includes an upper end member 112a, a lower end member 112b, a linking member 112c which connects the upper end member 112a and the lower end member 112b, and a handle 112d. The upper end member 112a is fixed to a slider 104 of the guide unit 102. The handle 112d is a handle to operate a screw shaft—nut mechanism provided in the linking member 112c. The operator can rotate this handle 112d to cause the linking member 112c to expand or contract in a direction in which the upper end members 112a and 112b will be brought into contact with each other or separated from each other. The expansion and contraction direction of the expanding and contracting unit 112 is the Z direction.

The expanding and contracting unit 113 is also a pantograph jack in the case of this embodiment, and includes an upper end member 113a, a lower end member 113b, a linking mechanism 113c which connects the end member 113a and the end member 113b to each other, and a handle 113d. The lower end member 113b is fixed to the connecting unit 110. The handle 113d is a handle to operate a screw shaft—nut mechanism provided in the linking member 113c. The operator can rotate this handle 113d to cause the linking mechanism 113c to expand or contract in a direction in which the upper end members 113a and 113b will be brought into contact with each other or separated from each other.

The expanding and contracting unit 113 is swingably connected to the expanding and contracting unit 112 via a swing shaft 114 extending in the horizontal direction. Since the plurality of printheads 30 are supported by the carriage 31 in the case of this embodiment, the tilt of each printhead 30 in the vertical direction with respect to the Z direction changes depending on the printhead 30. By arranging the expanding and contracting unit 113 to be swingable, the expansion and contraction direction of the expanding and contracting unit 113 can be changed in correspondence with the tilt of each printhead 30.

Two bearings 112e which support the swing shaft 114 are arranged in the end member 112b of the expanding and contracting unit 112. Also, two bearings 113e which support the swing shaft 114 are arranged in the end member 113a of the expanding and contracting unit 113. The swing shaft 114 is inserted through the bearings 112e and 113e, thereby allowing the expanding and contracting unit 113 to swing from the expanding and contracting unit 112.

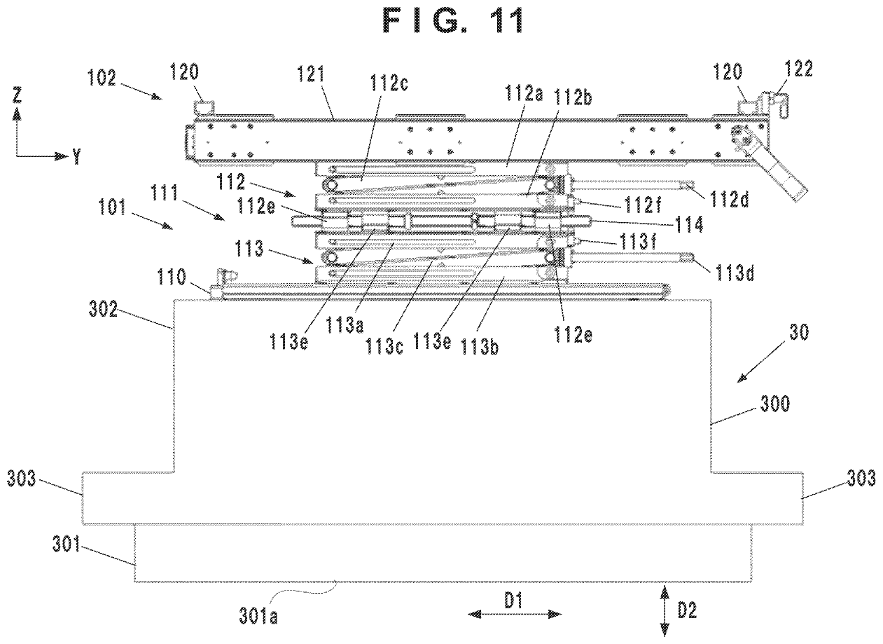

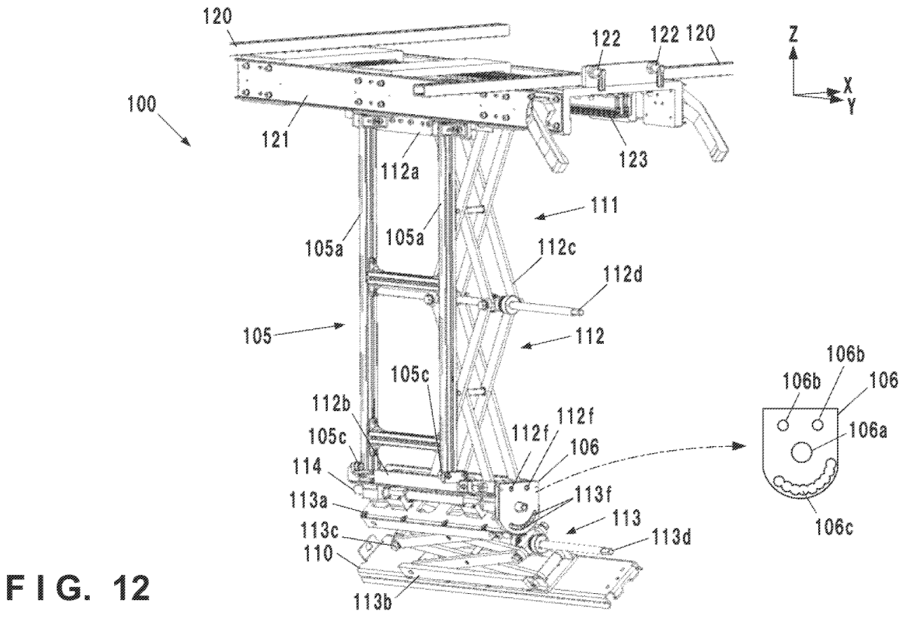

FIG. 12 shows an example of a mode in which the expanding and contracting units 112 and 113 have been expanded. In the example shown in FIG. 12, the expanding and contracting unit 113 swings about the swing shaft 114 with respect to the expanding and contracting unit 112, and the swing angle is locked by a lock member 106. The lock member 106 is detachably attached to the end of the slider 104, is a plate-like member that can lock the swing angle, and is used when the swing angle needs to be locked. The lock member 106 has a hole 106a through which the slider 104 is inserted, engaging portions 106b that engage with the end member 112b of the expanding and contracting unit 112, and an engaging portion 106c that engages with the end member 113a of the expanding and contracting unit 113.

Engaging portions 112f that engage with the engaging portions 106b are provided in the end member 112b of the expanding and contracting unit 112. In the case of this embodiment, each engaging portion 112f is a pin protruding from the side of the end member 112b, and each engaging portion 106b is a hole where the pin is inserted. In the case of this embodiment, there are two engaging portions 112f, and two engaging portions 106b are arranged in correspondence with these engaging portions.

Engaging portions 113f that engage with the engaging portion 106c are arranged in the end member 113a of the expanding and contracting unit 113. In the case of this embodiment, each engaging portion 113f is a pin protruding from the side of the end member 113a, and the engaging portion 106c is a hole where the pin is inserted. In the case of this embodiment, there are two engaging portions 113f. The corresponding engaging portion 106c is an array of holes formed continuously in an arc-shape centered about the swing shaft 114. It is possible to change the swing angle of the expanding and contracting unit 113 by selecting the holes where the engaging portions 112f are to be inserted, and lock the expanding and contracting unit 113 to the expanding and contracting unit 112 at the selected swing angle.

FIG. 12 also shows a state in which a reinforcing member 105 for reinforcing the expanding and contracting unit 112 has been attached. As shown in FIG. 12, if the printhead 30 is held by the connecting unit 110 in a state in which the expanding and contracting unit 113 is tilted in the Z direction, the expanding and contracting unit 113 and the printhead 30 will be supported by the expanding and contracting unit 112 in a cantilevered state. The reinforcing member 105 is a member that is shaped like the number sign and used selectively to maintain the perpendicular orientation of the expanding and contracting unit 112 in such a state.

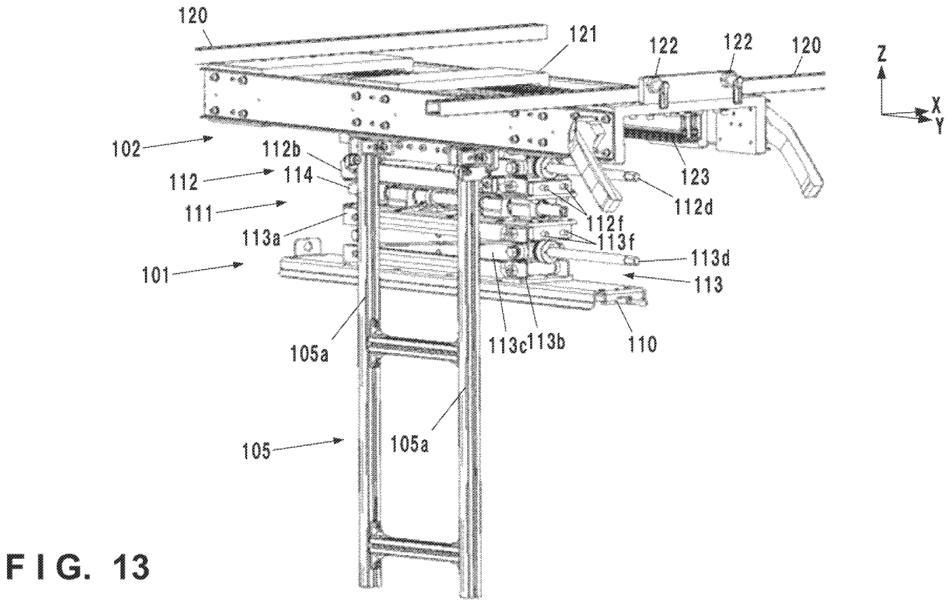

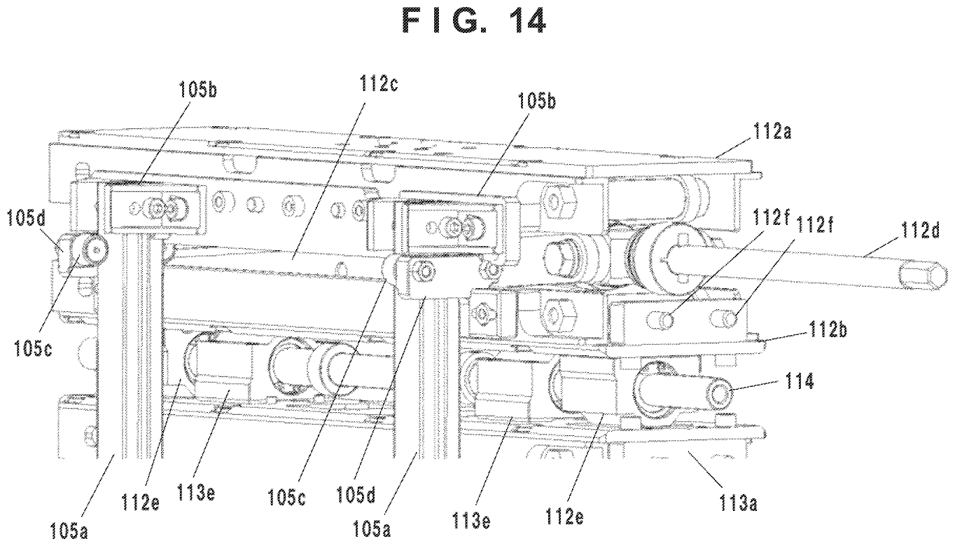

FIG. 13 shows a mode in which the reinforcing member 105 has been attached to the lifting unit 101 in a state in which the lifting unit 101 has contracted, and FIG. 14 shows the arrangement of the upper end of the reinforcing member 105. The reinforcing member 105 includes rail members 105a extending in the Z direction, and the upper ends of the rail members are detachably fixed to the end member 112a of the expanding and contracting unit 112 via brackets 105b. Rollers 105c are attached to the end member 112b of the expanding and contracting unit 112 via brackets 105d. Each roller 105c rolls on the side surface of the corresponding rail member 105a. When the expanding and contracting unit 112 expands from the contracted state, the expanding operation of the expanding and contracting unit 112 is performed smoothly by rolling the rollers 105c on the rail members 105a. Furthermore, the rigidity of the expanding and contracting unit 112 is reinforced by the rail members 105a, and it is possible to prevent the expanding and contracting unit 112 from warping.

The arrangement of the guide unit 102 will be described next with reference to FIGS. 10, 11, 15A, 15B, and 16. In the case of this embodiment, the guide unit 102 can guide the movement of the lifting unit 101 in the X direction and the Y direction. However, it may be set so that the direction of the movement of the lifting unit 101 may be one of the X direction and the Y direction. In this case, between the total length direction and the depth direction of the printing apparatus 1A, the depth direction (Y direction) is more advantageous in the point that the distance of the movement of the lifting unit 101 is small.

The guide unit 102 includes a pair of rail members 120 supported by the frames F shown in FIG. 9. Each rail member 120 extends above the recovery position POS3 in the X direction, and guides the movement of the lifting unit 101 in the X direction. The guide unit 102 includes a slider 121 that moves under the guidance of the pair of rail members 120. The slider 121 is frame arranged across the pair of rail members 120 and includes a pair of slide rails 123 inside. The pair of slide rails 123 is arranged spaced apart in the X direction. The expansion and contraction direction of each slide rail 123 is the Y direction, and the slide rail guides the movement of the lifting unit 101 in the Y direction.

The pair of slide rails 123 supports the slider 104. The slider 104 is fixed to the innermost movable rails of the pair of the slide rails 123 and moves together with the movable rails in the Y direction. The slider 104 includes a base member 104a installed between the pair of slide rails 123 and a connecting member 104b supported by the base member 104a.

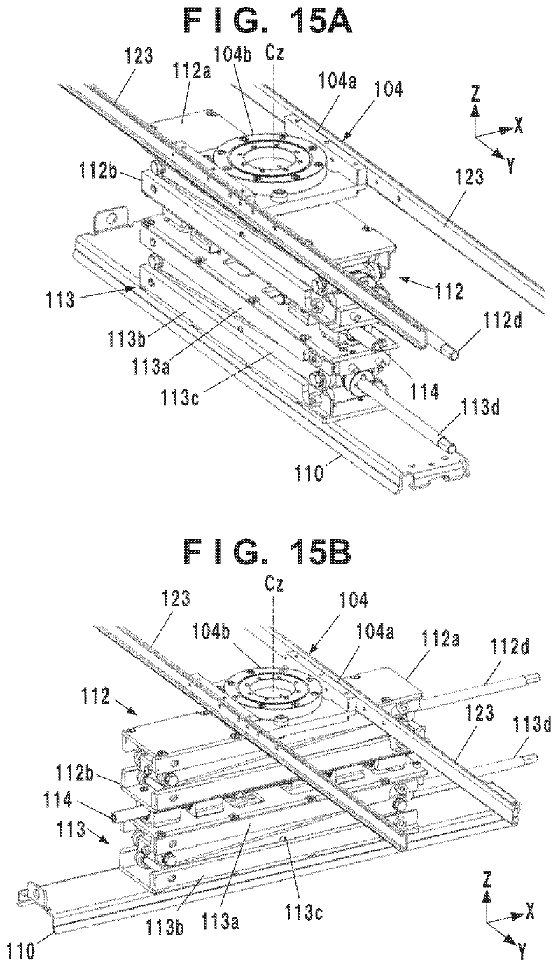

The connecting member 104b is a member that connects the lifting unit 101 and the guide unit 102 to each other and connects the base member 104a to the end member 112a of the expanding and contracting unit 112 in this case. The connecting member 104b is formed from two members that can pivot about a center shaft Cz in the Z direction. One member is fixed to the base member 104a and the other member is fixed to the end member 112a. Hence, the lifting unit 101 can pivot about the center shaft Cz which serves as the vertical axis. FIGS. 15A and 15B show examples of the pivotal motion of the lifting unit 101. FIG. 15A shows the pivot position of the lifting unit 101 when the printhead 30 is to be inserted into or removed from the carriage 31, and FIG. 15B shows the pivot position obtained by pivoting the lifting unit 101 from the pivot position shown in FIG. 15A by 90°. A larger work space can be ensured in some cases by changing the orientation of the lifting unit 101 to the pivot position shown in FIG. 15B during the process of conveying the printhead 30 to the outside of the outside.

The guide unit 102 includes lock units 122 that can lock the position of the lifting unit 101 in the X direction. In the case of this embodiment, the lock units 122 are supported by the slider 121 and lock the position of the slider 121 in the X direction by engaging with the frame F. This locks the position of the lifting unit 101 in the X direction.

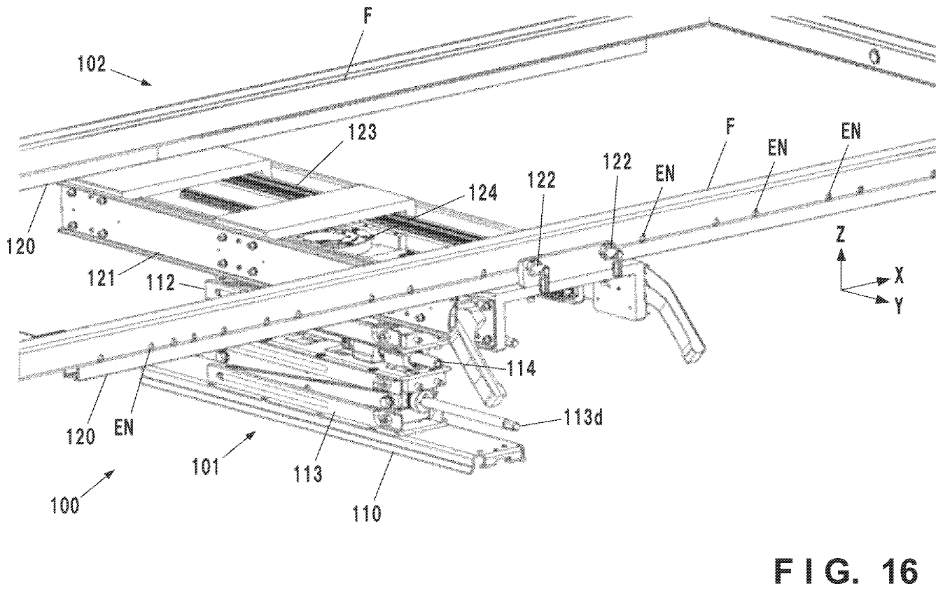

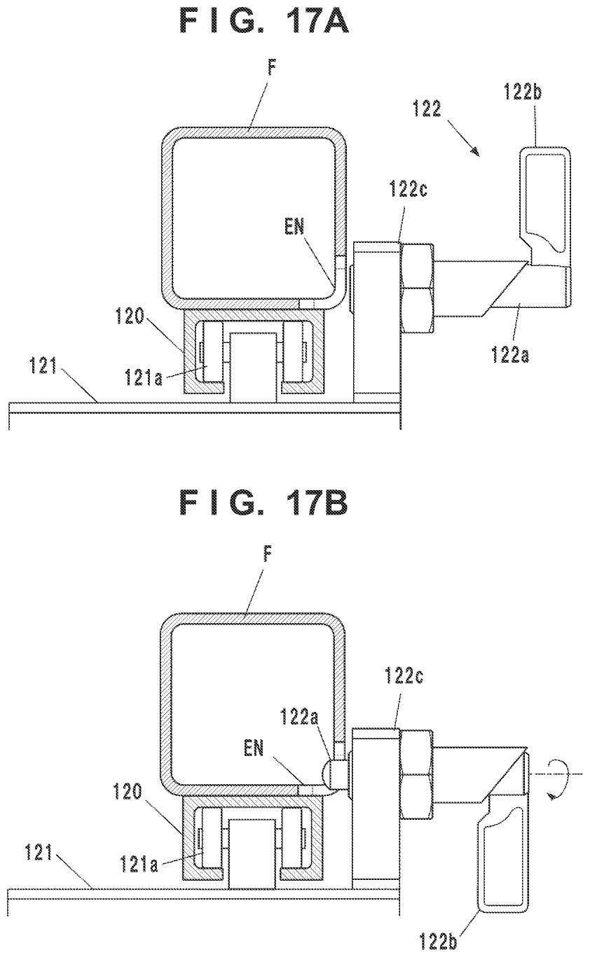

Each lock unit 122 will be described with reference to FIGS. 16, 17A, and 17B. Engaging portions EN are formed at positions where the lifting unit 101 is expected to stop on the frame F which supports the corresponding rail member 120. In the case of this embodiment, each engaging portion EN is a hole. FIGS. 17A and 17B are explanatory views of the operation of the lock unit 122 and show a vertical sectional view of the engaging portion EN.

Each rail member 120 has a C-shaped section with an opening in its lower portion, and rollers 121a of the slider 121 are contained inside in a rollable manner. The rail member 120 is fixed to the lower surface of the corresponding frame F which is shaped like a square steel pipe. The engaging portions EN are formed on the lower portion of the side surface of the frame F. FIG. 17A shows an unlocked state, and FIG. 17B shows a locked state. Each lock unit 122 includes a pin member 122a, a handle 122b connected to the pin member 122a, and a support member 122c that supports the pin member 122a so that the pin member will be movable with respect to the corresponding engaging portion EN. The support member 122c is fixed to the slider 121.

When the operator pivots the handle 122b about the shaft line of the pin member 122a in the manner shown in FIG. 17B from the state of FIG. 17A, the pin member 122a enters the engaging portion EN and is set in an engaged state. This will disable the movement of the slider 121 in the X direction and lock the position of the lifting unit 101 in the X direction. When the handle 122b is operated in reverse, the state returns to the state shown in FIG. 17A, the lock placed on the position of the lifting unit 101 in the X direction is released and the movement of the slider 121 in the X direction is enabled.

(Replacement Operation)

An example of the replacement operation of the printhead 30 using the work support apparatus 100 will be described. First, an operation performed to remove the printhead 30 from the carriage 31 and to convey the printhead 30 to a work table 200 on the far side of the recovery unit 12 will be described with reference to FIG. 8 and FIGS. 18 to 26.

FIG. 8 assumes a case in which the printhead 30 that is positioned at the leftmost edge of the carriage 31 shown in FIG. 8 is to be removed. First, as shown in FIG. 8, the lifting unit 101, which is in a contracted state, is moved above the removal-target printhead 30 by the operator. At this time, the movement of the lifting unit 101 is guided by the guide unit 102. The operator uses the lock units 122 to lock the position of the lifting unit 101 in the X direction.

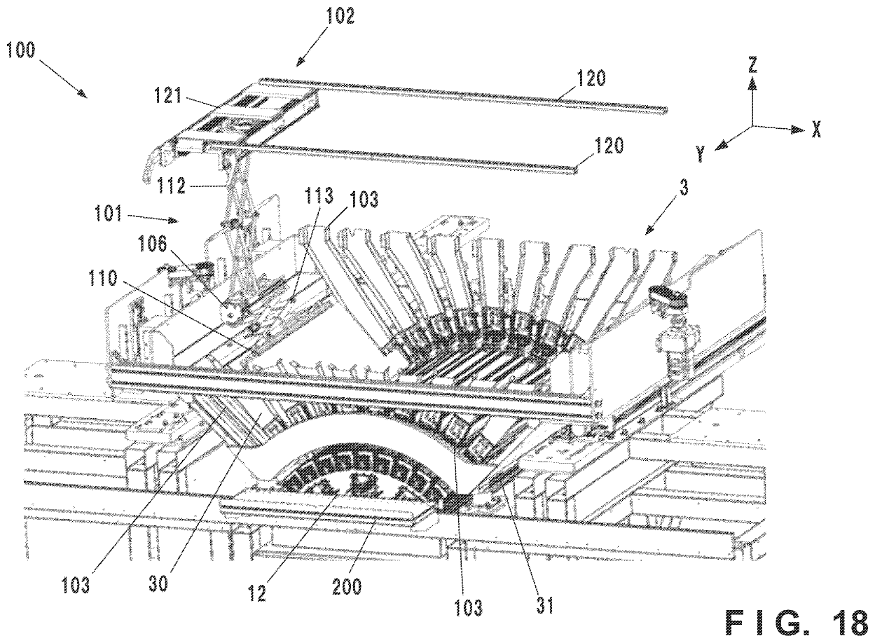

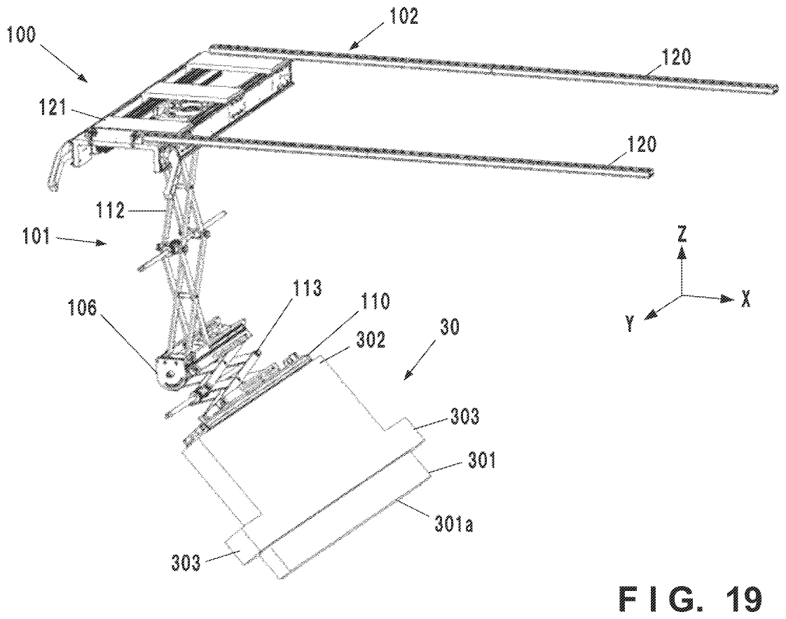

As shown in FIG. 18, the lifting unit 101 expands and connects the connecting unit 110 to the printhead 30. FIG. 19 shows an extracted image of the work support apparatus 100 and the printhead 30 at the step of FIG. 18. Both of the expanding and contracting units 112 and 113 are in an expanded state. The expanding and contracting unit 113 is swung in accordance with the tilt of the printhead 30, and its swing angle is locked by the lock member 106. Although it is not shown in the example of FIG. 19, the reinforcing member 105 may be used.

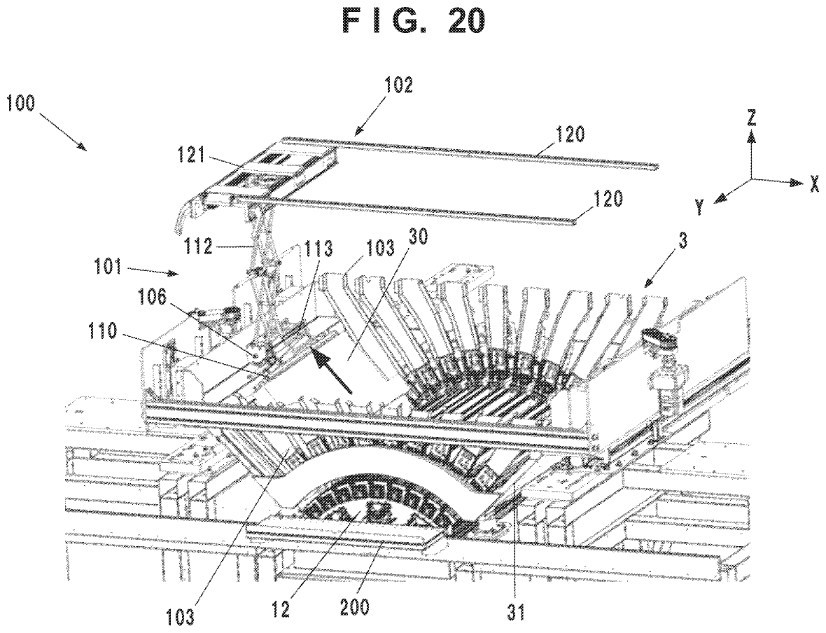

If the printhead 30 is joined to the carriage 31 by a bolt or the like, the joint is released. Next, as shown in FIG. 20, the expanding and contracting unit 113 contracts to lift the printhead 30 upward from the carriage 31. The lifting direction in this case is the direction of the tilt of the printhead 30 (the swing angle direction of the expanding and contracting unit 113). Note that the expanding and contracting unit 112 does not contract at this time.

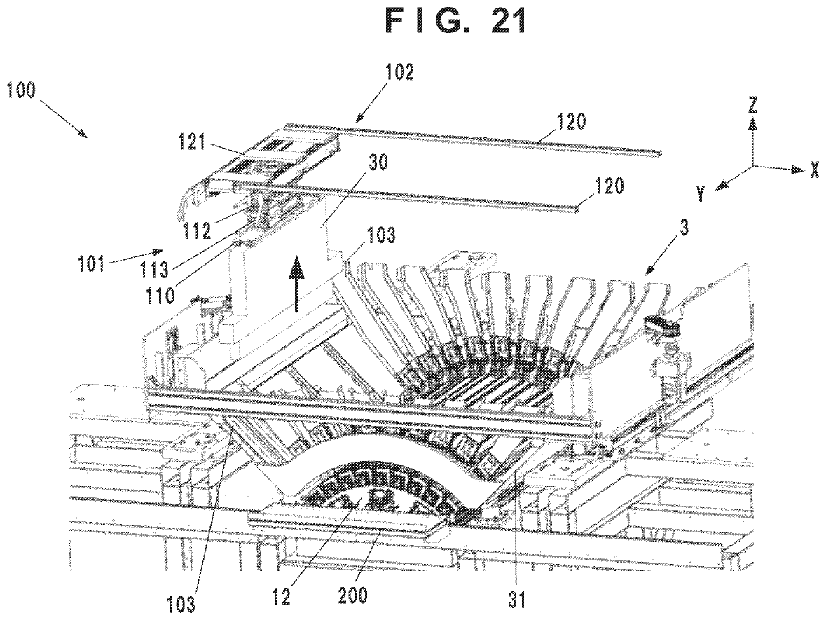

Next, the lock placed on the swing angle of the expanding and contracting unit 113 is unlocked by removing the lock member 106, and the printhead 30 is lifted up from the carriage 31 in the Z direction by contracting the expanding and contracting unit 112 in the manner shown in FIG. 21. As a result, the printhead 30 is positioned above the carriage 31.

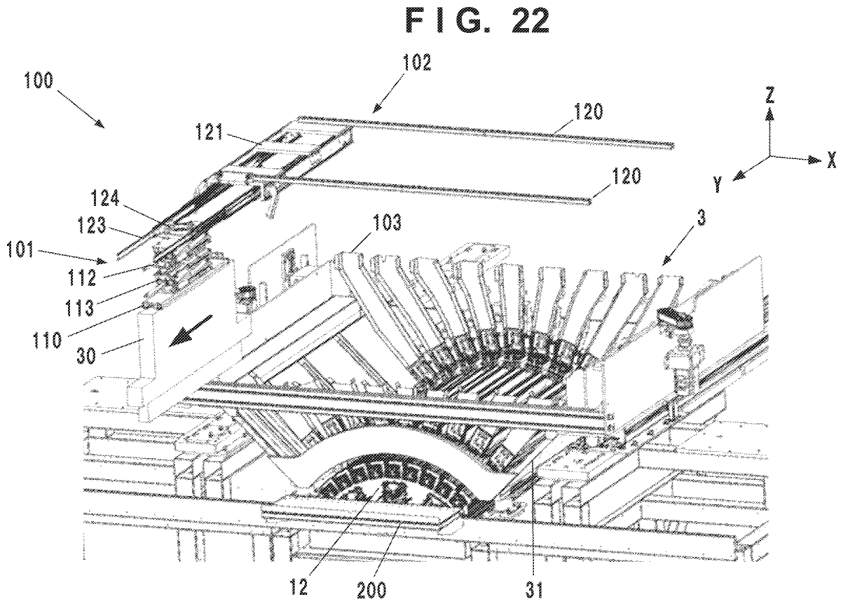

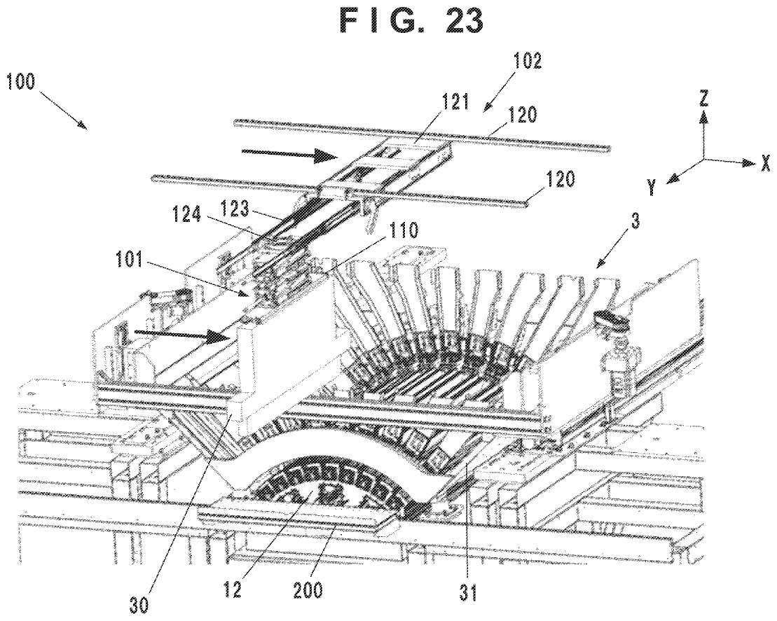

As shown in FIG. 22, the slide rails 123 are expanded. The printhead 30 moves together with the lifting unit 101 in the Y direction and essentially moves outside the printing apparatus 1A. The lock placed by the lock units 122 on the position of the lifting unit 101 in the X direction is unlocked, and the slider 121 moves in the X direction as shown in FIG. 23. The printhead 30 moves together with the lifting unit 101 in the X direction and arrives above the work table 200. The operator uses the lock units 122 to lock the position of the lifting unit 101 in the X direction again.

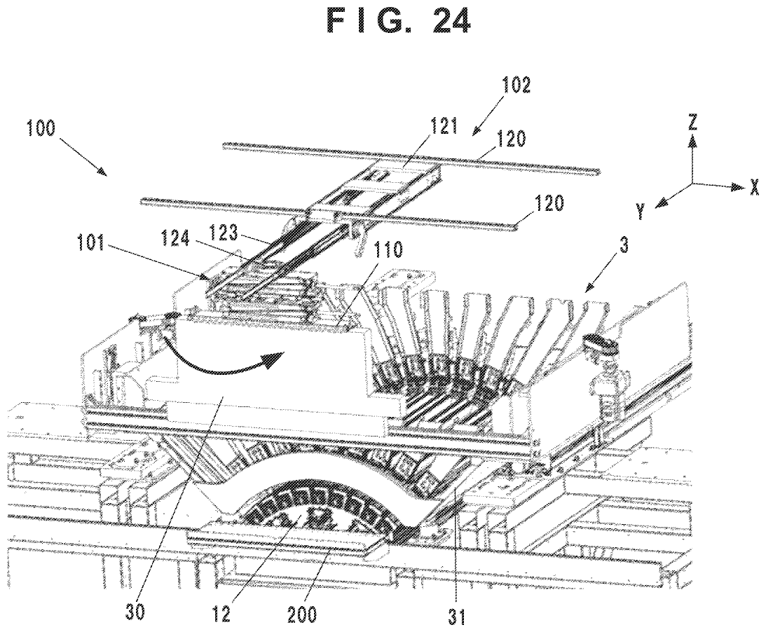

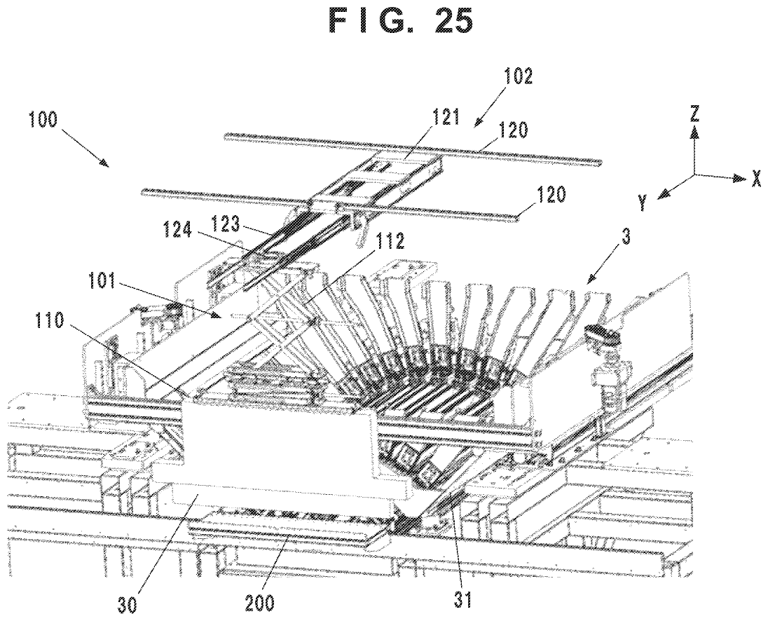

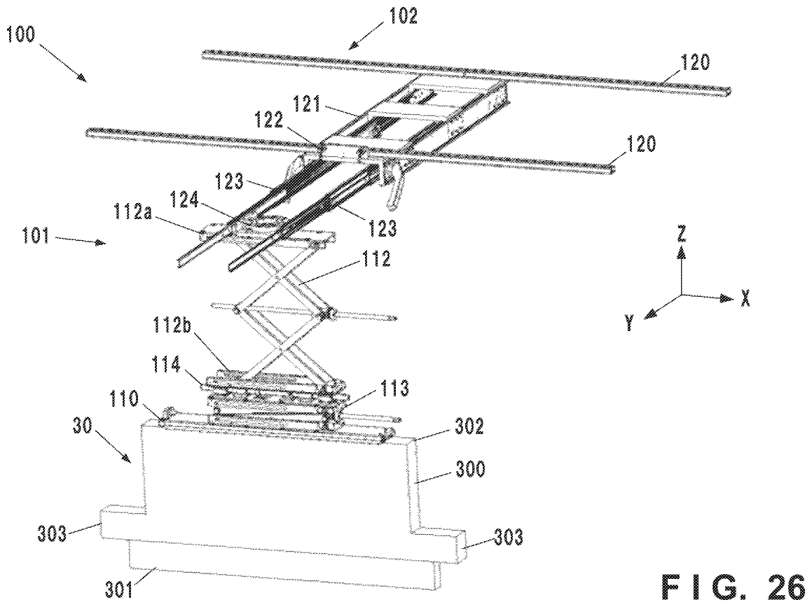

As shown in FIG. 24, the orientation of the lifting unit 101 is pivoted 90°. The printhead 30 is also pivoted 90°. As shown in FIG. 25, the lifting unit 101 expands to lower the printhead 30 onto the work table 200. FIG. 26 shows an extracted image of the work support apparatus 100 and the printhead 30 at the step of FIG. 25. The lifting unit 101 expands for only an amount necessary to lower the printhead 30. Subsequently, the printhead 30 is removed from the connecting unit 110.

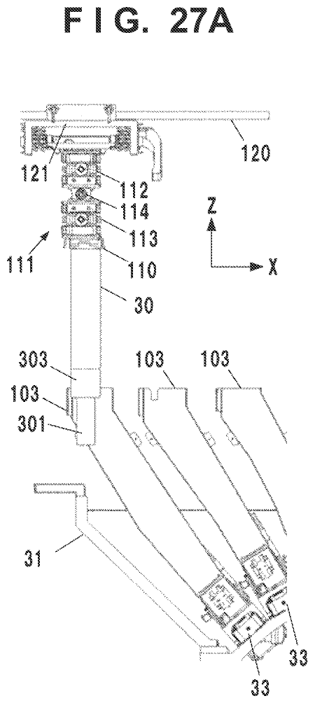

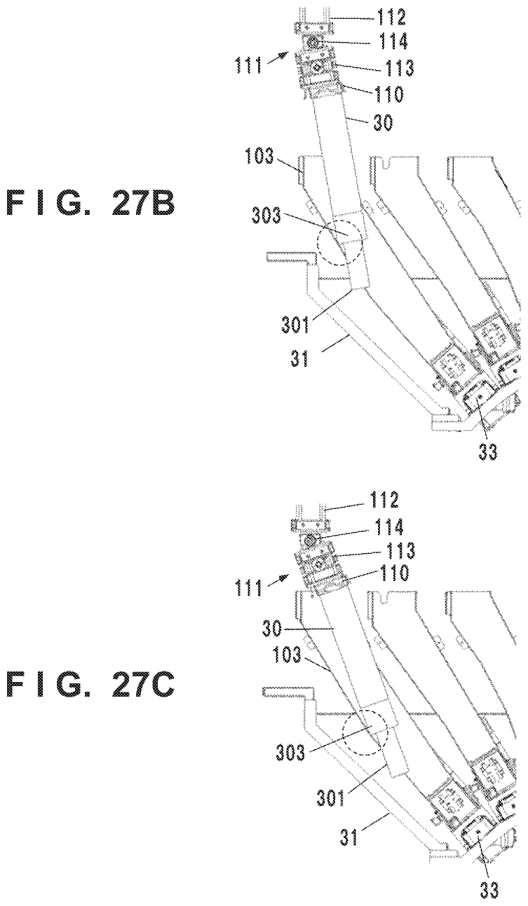

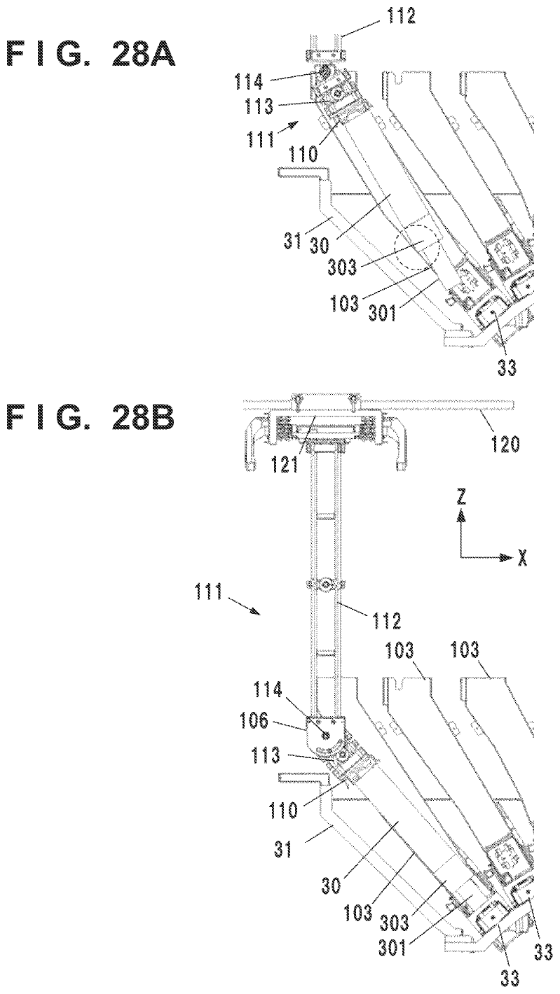

The operation performed to attach the printhead 30 to the carriage 31 will be described next. In the attachment operation, the printhead 30 to be attached is conveyed from the work table 200 to the carriage 31. Since the procedure of this operation is basically the reverse of the removal operation, a description will be omitted. In the following description, the function of the guide member 103 when the work support apparatus 100 lowers the printhead 30 to the carriage 31 to attach the printhead to the carriage 31 will be mainly described with reference to FIGS. 27A to 28B.

FIG. 27A shows a state in which the printhead 30 has been conveyed by the work support apparatus 100 to a position above the carriage 31. It is a state identical to the state of FIG. 21 when the printhead is removed. The operator uses the lock units 122 to lock the position of the lifting unit 101 in the X direction again. Also, the reinforcing member 105 is attached to the expanding and contracting unit 112 as needed.

After the expanding and contracting unit 112 has expanded, the engaging portions 303 of the printhead 30 start to abut against the guide member 103 as shown in FIG. 27B. The expanding and contracting unit 113 is swingably connected to the expanding and contracting unit 112 via the swing shaft 114. Hence, as shown in FIGS. 27C and 28A, the orientation change (tilting) of the printhead 30 is guided by the guide member 103 by the abutment of the engaging portions 303 and the guide member 103 as the expanding and contracting unit 112 expands in the Z direction. As a result, the expanding and contracting unit 113 swings accordingly. As a result, the printhead 30 will be guided into an appropriate orientation under the guidance of the guide member 103 when the printhead 30 is lowered.

The printhead 30 will be positioned by the expansion of the expanding and contracting unit 112 at a position where the lower portion 301 of the printhead 30 can be attached to an attachment portion 33 of the carriage 31. Here, as shown in FIG. 28B, the lock member 106 will lock the swing angle of the expanding and contracting unit 113. Subsequently, the printhead 30 can be attached to the attachment portion 33 by expanding the expanding and contracting unit 113.

(Example of External Arrangement of System)

An example of the external arrangement of the printing system 1 will be described with reference to FIG. 29. FIG. 29 is an external perspective view of a structure 400 surrounding the printing apparatus 1A and the conveyance apparatus 1B. The structure 400 according to this embodiment is a hollow structure with walls formed by attaching panels to a lattice-like frame. The frame is formed by welding, for example, square pipes and each panel is, for example, a metal sheet. Although the structure 400 according to the embodiment surrounds the printing apparatus 1A and the conveyance apparatus 1B entirely, it may be a structure that surrounds some parts of the apparatuses. By arranging the structure 400, the printing apparatus 1A and the conveyance apparatus 1B can be protected inside, and their operation environment can be stabilized.

The structure 400 includes an immobile main body portion 408 and movable parts 401 to 403 which are arranged to be displaceable. In the case of this embodiment, the movable parts 401 and 402 are sliding doors that can be opened and closed in the X direction. The movable parts 401 and 402 may also be referred to as sliding doors in this specification. FIG. 29 shows a state in which the sliding doors 401 and 402 are at the closed position. In the case of this embodiment, the movable part 403 is a top surface cover that covers the upper part of the printing apparatus 1A and can open and close in the Z direction. The movable part 403 may also be referred to as the top surface cover 403 in this specification. FIG. 29 shows a state in which the top surface cover 403 is at the closed position.

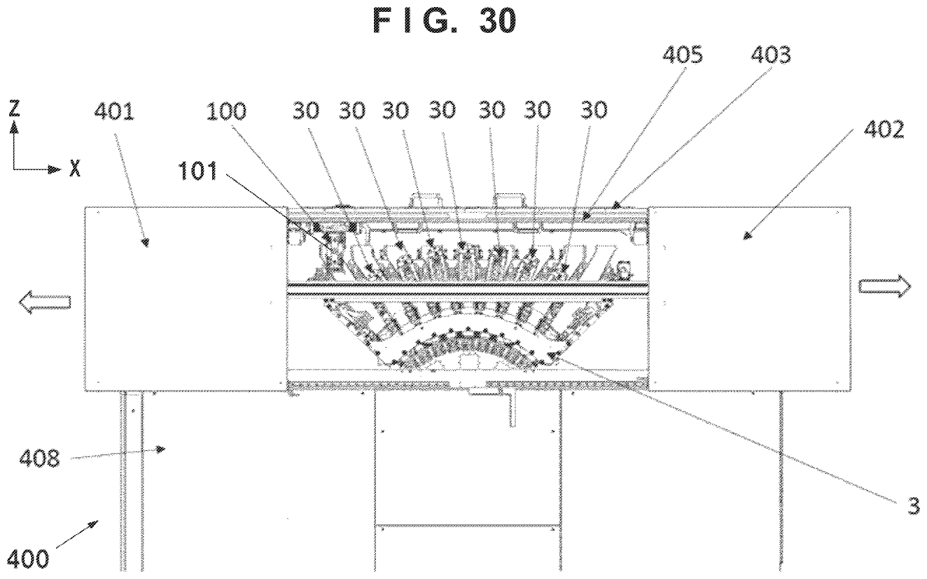

FIG. 30 shows a state in which the sliding doors 401 and 402 are at the open position. Displacing the sliding doors 401 and 402 to the open position exposes the print unit 3 in which the printheads 30 are radially arranged inside the structure 400. The work support apparatus 100 arranged inside the top surface cover 403 is also exposed. As shown in FIG. 30, when the top surface cover 403 is at the closed position, the lifting unit 101 of the work support apparatus 100 is positioned at a position (storage position) shifted from the center of the print unit 3 in the X direction. In the case of this embodiment, the lifting unit 101 is arranged above the printhead 30 which is positioned at the farthest end in the X direction. Since the printheads 30 are arranged radially, the distance in the Z direction with respect to the top surface cover 403 of the printhead 30 which is positioned at the center in the X direction differs from that of the printhead 30 which is positioned at the end in the X direction. Since there is a comparatively large space between the top surface cover 403 and the printhead 30 positioned at the end in the X direction, the internal space of the structure 400 can be used efficiently by positioning the lifting unit 101 in this space. As long as the lifting unit 101 is in this storage position, the lifting unit 101 and the printheads 30 will not come into contact with each other even when print unit 3 moves during the printing operation.

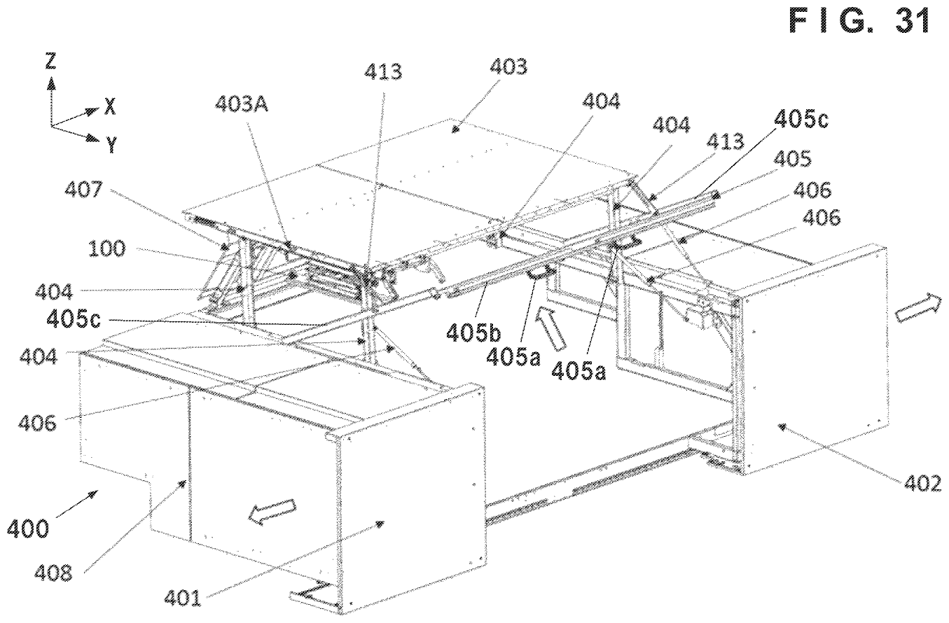

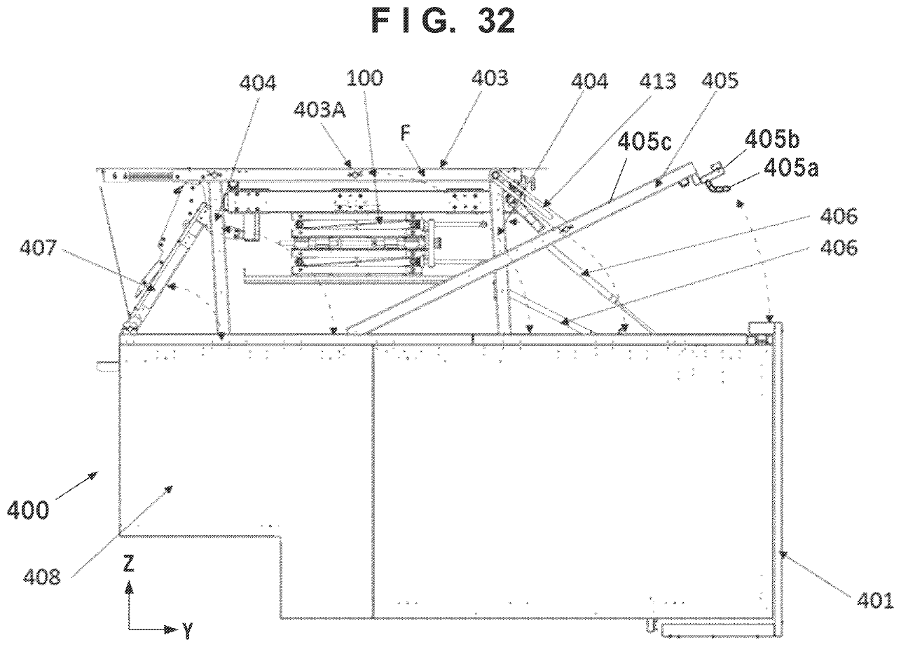

FIGS. 31 and 32 are external views of the top surface cover 403 at the open position. FIG. 31 is a perspective view, and FIG. 32 is a view of the structure 400 seen in the X direction. At the open position, the top surface cover 403 is at position which is higher than the closed position in the Z direction and is shifted in the Y direction. In the case of this embodiment, the top surface cover 403 is moved in a parallel manner to the closed position and the open position by a linking mechanism formed by a plurality of linking members 404. One end of each linking member 404 is pivotally supported by the main body portion 408 and the other end of each linking member is pivotally supported by the top surface cover 403.

An opening and closing lever 405 is a U-shaped member arranged for the operator to perform an operation to open or close the top surface cover 403. The opening and closing lever 405 includes a bar-like portion 405b, which extends in the X direction and on which holding portions 405a are arranged, and a pair of bar-like portions 405c arranged at both ends of the portion 405b. Each portion 405c is pivotally supported by the main body portion 408.

A plurality of gas springs 406 are arranged between the top surface cover 403 and the main body portion 408. While the gas springs 406 are arranged to assist the operating force of the operator when the top surface cover 403 is displaced from the closed position to the open position in one hand, they also reduce the speed of the movement of the displacement when the top surface cover 403 is displaced from the open position to the closed position. In other words, the gas springs 406 will bias the top surface cover 403 in a direction that can displace the top surface cover to the open position, and will resist a direction that can displace the top surface cover to the closed position. A plurality of stopper frames 407 are members that restrict the orientation of the top surface cover 403 and the linking mechanism when the top surface cover 403 is at the open position. The top surface cover 403 includes the rectangular frame F, and the frame F supports the work support apparatus 100 (particularly, the guide unit 102).

The procedure in which the top surface cover 403 is displaced from the closed position to the open position will be described. When the operator lifts the holding portions 405a of the opening and closing lever 405 upward, the opening and closing lever 405 pushes a convex portion 403A provided on the top surface cover 403, and the entire top surface cover 403 begins to rise. The top surface cover 403 which is supported by the four linking members 404 is further assisted by the expansion force of the gas springs 406 to move upward while maintaining an almost parallel orientation.

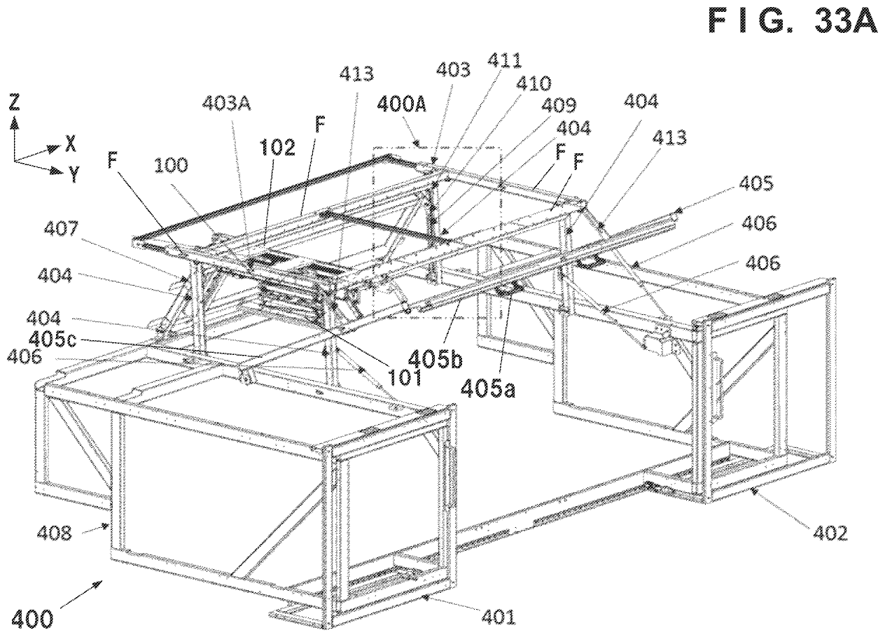

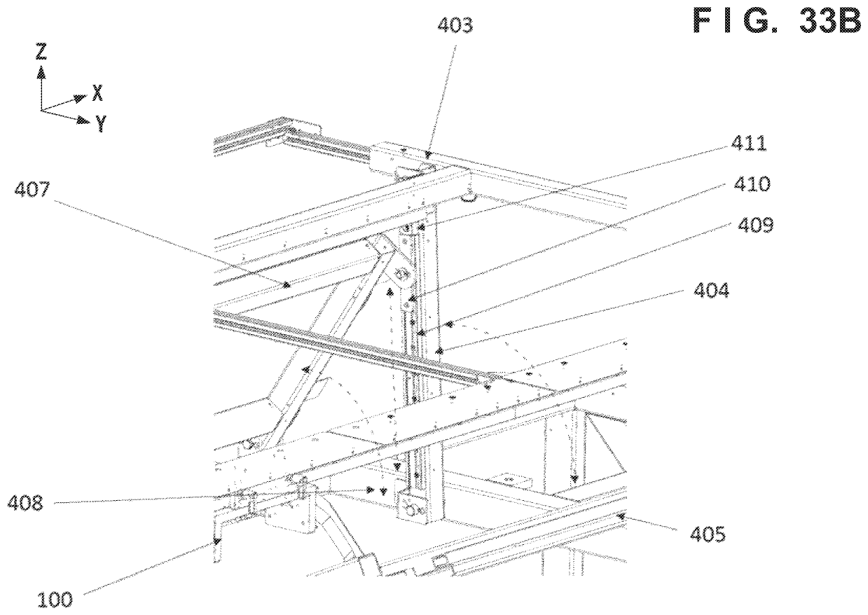

FIG. 33A is an external perspective view of the structure 400 showing the top surface cover 403 at the open position, and is, in particular, a view in which the illustration of the panels of the structure 400 has been omitted. FIG. 33B is a partially enlarged view of a portion 400A of the structure 400 shown in FIG. 33A. One end of each stopper frame 407 is pivotally supported by a main frame forming the main body portion 408, and the other end, which is on the opposite side of the one end of each stopper frame, is pivotally supported by a corresponding sliding member 410. The sliding member 410 is slidable in the longitudinal direction of the linking member 404 under the guidance of a rail member 409 arranged in the linking member 404. The sliding member 410 slides, in accordance with the pivotal motion of the linking member 404, until it abuts against a slider stopper 411 arranged at the end of the rail member 409. The pivotal motion of the linking member 404 and the movement of the top surface cover 403 stop when the sliding member 410 abuts against the slider stopper 411. The orientation of each linking member 404 and that of the top surface cover 403 are maintained by the biasing force of the plurality of gas springs 406.

The procedure in which the top surface cover 403 is displaced from the open position to the closed position will be described. When the operator lowers the holding portions 405a of the opening and closing lever 405 downward, a force in a direction to lower the top surface cover 403 via lever linking members 413 is applied. One end of each lever linking member 413 is pivotally supported by the opening and closing lever 405. Also, a groove where a pin arranged in the top surface cover 403 is to slide is formed in each lever linking member 413 in the longitudinal direction of the lever linking member 413. When the top surface cover 403 is lowered, the pin engages with the end of the groove and the force in the direction to lower the top surface cover 403 is applied. The top surface cover 403 is displaced to the closed position while the speed of the displacement of the top surface cover 403 is reduced by the biasing force of the plurality of gas springs 406.

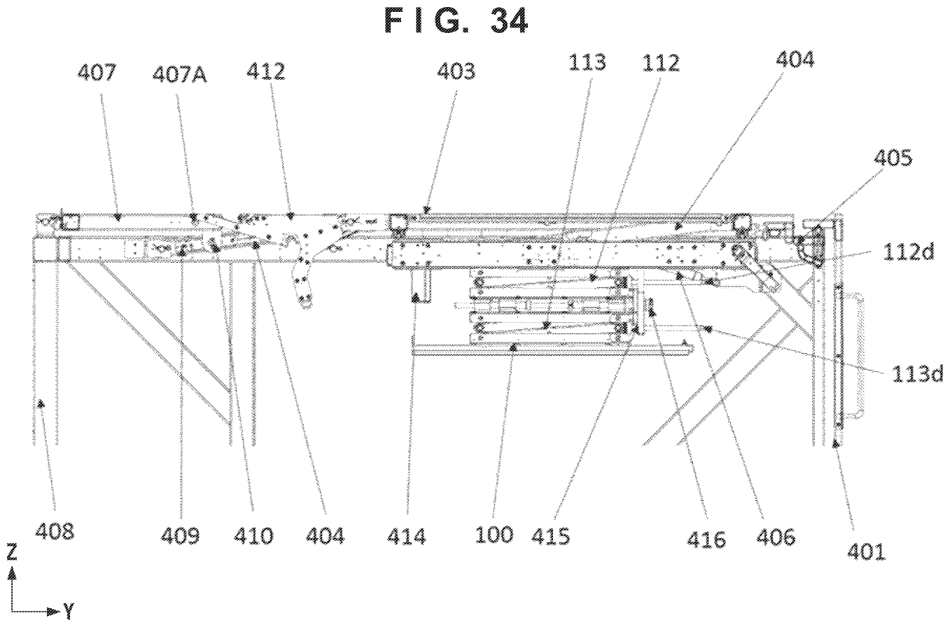

A link lock member 412 that restricts the orientation of the linking mechanism formed by each linking member 404 and the top surface cover 403 will be described. FIG. 34 is an explanatory view showing a state in which the top surface cover 403 is at the closed position. The link lock member 412 is pivotally supported by the top surface cover 403. Also, the end of the link lock member 412 is mounted on the stopper frame 407. The link lock member 412 is set in an orientation supported by the stopper frame 407 in a state in which the top surface cover 403 is closed.

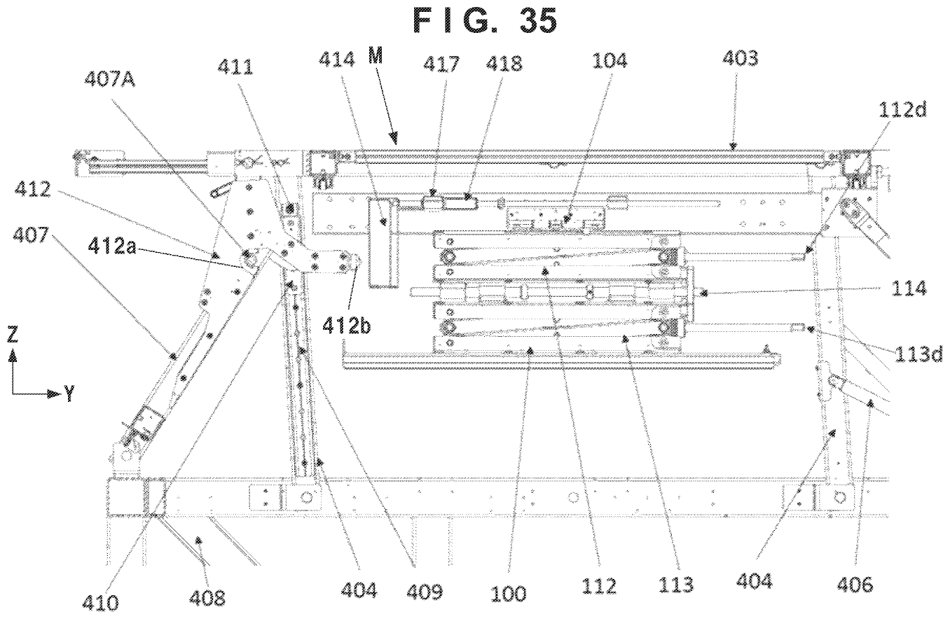

FIG. 35 is an explanatory view of a state in which the top surface cover 403 has been displaced to the open position and is locked by the link lock member 412. When each stopper frame 407 moves in the process in which the top surface cover 403 is displaced from the closed position to the open position, the orientation of the link lock member 412 changes due to the change in the relative position of the end which is supported by the stopper frame 407. The change in the orientation may be performed by using the weight of the member itself or the biasing force of a spring or the like that has been arranged separately. When the top surface cover 403 has been displaced to the open position, a hook-shaped engaging portion 412a of the link lock member 412 engages with a shaft portion 407A of the stopper frame 407. The orientation of the top surface cover 403 and that of each stopper frame 407 are restricted in a state in which the engaging portion of the link lock member 412 and the shaft portion 407A of the corresponding stopper frame 407 are engaged, and the relative positions of both the top surface cover and each stopper frame cannot be changed. The top surface cover 403 cannot be lowered even if the opening and closing lever 405 is operated in this state. To release the restriction, the link lock member 412 is moved by a lock release lever 414, and the engaging portion 412a is removed from the shaft portion 407A. As a result, the top surface cover 403 can be lowered to the closed position.

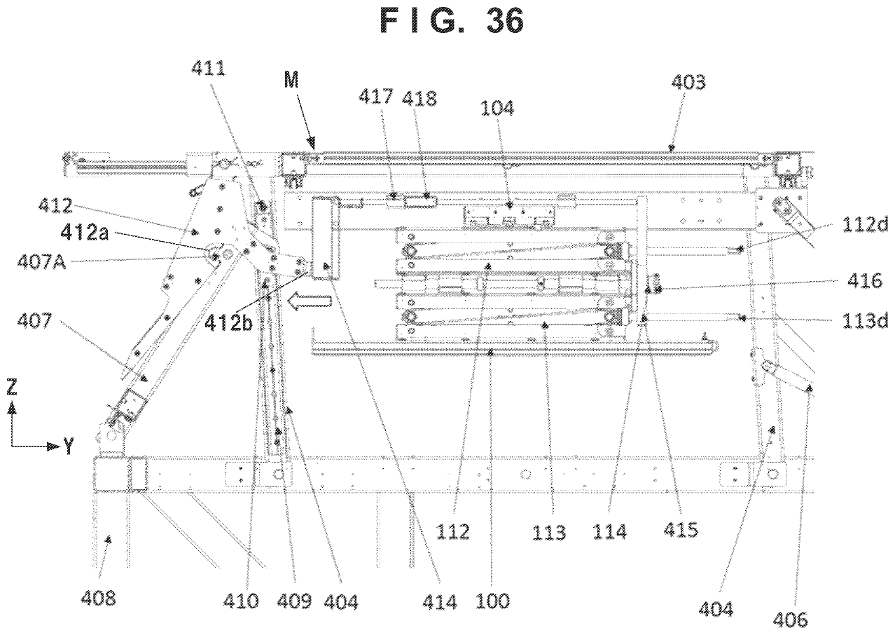

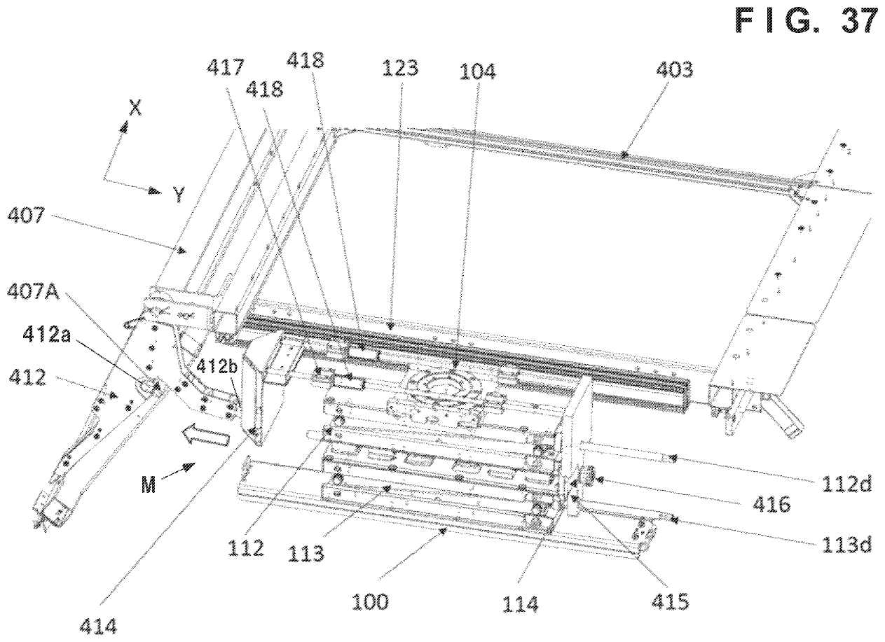

FIG. 36 is an explanatory view of a state in which the top surface cover 403 is at the open position, and the restriction by the link lock member 412 has been released. FIG. 37 is an explanatory view showing a release mechanism M which includes the lock release lever 414. The release mechanism M is a mechanism that can release the restriction by the link lock member 412, and includes the lock release lever 414 and a guide mechanism 417. The lock release lever 414 is attached near the work support apparatus 100 and can be displaced in the X direction and the Y direction under the guidance of the guide mechanism 417. When the lock release lever 414 moves to the farthest end in the Y direction (toward the left in FIG. 36) and is positioned at the same location as the link lock member 412 in the X direction, the lock release lever 414 can push a protruding portion 412b of the link lock member 412 to pivot the link lock member 412 in the release direction. Normally, as shown in FIG. 35, the lock release lever 414 is biased by a release lever spring 418 and is apart from the link lock member 412.

An expanding and contracting lock unit 415 is a member that is detachably attached to the expanding and contracting unit 111, and is a member configured to restrict the lifting unit 101 in the contracted state. The expanding and contracting lock unit 415 can be fitted to the handles 112d and 113d and the swing shaft 114 when the expanding and contracting units 112 and 113 of the work support apparatus 100 are in their most contracted state. The screw portion at the end of the swing shaft 114 can be used to attach the expanding and contracting lock unit 415 to the expanding and contracting unit 111 by an attachment knob 416. When the expanding and contracting lock unit 415 is attached to the expanding and contracting unit 111 in a state in which the position of the lifting unit 101 in the X direction is positioned at the storage position, the lock release lever 414 is pushed in synchronization with the attachment and moves to the farthest end in the Y direction to push the protruding portion 412b of the link lock member 412. As a result, the restriction of the top surface cover 403 and the linking mechanism by the link lock member 412 is released. That is, the top surface cover 403 cannot be displaced to the closed position unless the lifting unit 101 is positioned at the storage position and the expanding and contracting unit 111 is restricted in a contracted state by the expanding and contracting lock unit 415. This can prevent a part of the work support apparatus 100 from interfering with the carriage 31 and the printheads 30 if the lifting unit 101 accidentally expands during a printing operation. By setting the position of the link lock member 412 to be a position corresponding to the storage position of the lifting unit 101 when the top surface cover 403 is to be closed, it will not be possible to close the top surface cover 403 unless the work support apparatus 100 is contracted and stored. Note that the position of the lifting unit 101 in the X direction can be restricted by the lock unit 122 described above and can be restricted to the storage position.

The procedure related to the structure 400 at the time of the replacement operation by the work support apparatus 100 will be described next. First, the sliding door 401 and the sliding door 402 are opened to the left and to the right, respectively, and the holding portions 405a of the opening and closing lever 405 are lifted upward. The expanding and contracting lock unit 415 is removed from the expanding and contracting unit 111 of the work support apparatus 100 in a state in which the top surface cover 403 has been displaced to the open position. The orientation of the top surface cover 403 and that of the linking mechanism are restricted by the link lock member 412, and the top surface cover 403 is maintained at the open position during the replacement operation. Subsequently, the lock units 122 are unlocked to allow the lifting unit 101 to move from the storage position.

After the replacement operation has been completed, the lifting unit 101 is moved to the storage position, and the position of the lifting unit 101 in the X direction is locked by the lock units 122. The expanding and contracting units 112 and 113 of the work support apparatus 100 are set to their most contracted state, and the expanding and contracting lock unit 415 is attached. As a result, the restriction by the link lock member 412 is released. Next, the top surface cover 403 is closed by lowering the holding portions 405a of the opening and closing lever 405. The left sliding door 401 and the right sliding door 402 are closed from the left and from the right, respectively.

### Other Embodiments

Although the contracting and expanding of the lifting unit 101 and the moving of the lifting unit 101 in the horizontal direction by the guide unit 102 were both performed manually in the case of the above-described embodiment, all or some of these operations may be automated. In such a case, an actuator such as an air cylinder or an electric cylinder may be used as the expanding and contracting unit 111 of the lifting unit 101. In addition, a ball screw mechanism, a belt driving mechanism, or the like which has a motor as a driving source, can be used to move the lifting unit 101 in the horizontal direction.

In addition, although the above embodiment described an example in which the work support apparatus 100 is used in the transfer type printing apparatus 1A, the work support apparatus 100 is applicable to a printing apparatus which operates under method in which an image is printed on a print medium such as paper or the like by discharging ink directly to the print medium.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2018-148722, filed Aug. 7, 2018, and No. 2019-096251, filed May 22, 2019, which are hereby incorporated by reference herein in their entirety.

What is claimed is:

1. A printing system comprising:
a printing apparatus that includes a printhead which discharges ink and a carriage which supports the printhead;
a lifting unit configured to lift the printhead from the carriage; and
a guide unit configured to guide the lifting unit to move in a horizontal direction.

2. The system according to claim 1, wherein the printhead includes an upper portion and a lower portion on which a discharge surface that discharges ink is arranged, and
the lifting unit includes
a connecting unit which is connected to the upper portion of the printhead, and
an expanding and contracting unit between the connecting unit and the guide unit.

3. The system according to claim 2, wherein the expanding and contracting unit includes
a first expanding and contracting unit on a side of the guide unit and
a second expanding and contracting unit on a side of the connecting unit, and
the second expanding and contracting unit is swingably connected to the first expanding and contracting unit.

4. The system according to claim 3, wherein the first expanding and contracting unit is arranged so that an expansion and contraction direction will be a vertical direction.

5. The system according to claim 3, wherein a swing angle of the first expanding and contracting unit and the second expanding and contracting unit can be locked.

6. The system according to claim 1, wherein the guide unit is configured to guide the lifting unit to move in a first horizontal direction and a second horizontal direction which intersects with the first horizontal direction.

7. The system according to claim 6, wherein the printhead includes a nozzle array which discharges ink,
the first horizontal direction is an array direction of the nozzle array, and
a position of the lifting unit in the second horizontal direction can be locked.

8. The system according to claim 6, wherein the printhead includes a nozzle array which discharges ink,
the first horizontal direction is an array direction of the nozzle array, and
the guide unit includes
a rail member which extends above the carriage in the second horizontal direction,
a slider which moves in the second horizontal direction under guidance of the rail member, and
a slide rail which is arranged on the slider and contracts in the first horizontal direction.

9. The system according to claim 1, wherein the lifting unit is configured to be pivotally connected to the guide unit about a vertical axis.

10. The system according to claim 1, wherein a guide member which guides attachment of the printhead to the carriage is arranged in the carriage.

11. The system according to claim 1, wherein the carriage is arranged to be movable between a discharge position where the ink is discharged for printing and a recovery position where a discharge performance of the printhead is recovered, and
the lifting unit is configured to lift the printhead from the carriage when the carriage is positioned at the recovery position.

12. The system according to claim 1, wherein the printing apparatus includes
a transfer drum,
a plurality of printheads supported by the carriage so as to be arranged radially around the transfer drum and configured to form an ink image on a transfer member of the transfer drum by discharging ink on the transfer member, and
a rotating body configured to transfer the ink image to a print medium on the transfer member, and
the lifting unit is configured to lift one printhead of the plurality of printheads from the carriage.

13. The system according to claim 1, further comprising:
a structure that surrounds the printing apparatus,
wherein the structure includes a cover arranged so as to be displaceable between a closed position where the cover covers the upper part of a carriage and an open position where the cover is placed at a position higher than the closed position, and
the lifting unit and the guide unit are arranged on the inner side of the cover.

14. The system according to claim 12, further comprising:
a structure that surrounds the printing apparatus,
wherein the structure includes a cover arranged so as to be displaceable between a closed position where the cover covers the upper part of a carriage and an open position where the cover is placed at a position higher than the closed position,
the lifting unit and the guide unit are arranged on the inner side of the cover, and
the lifting unit is arranged above a printhead positioned at a farthest end among the plurality of printheads when the cover is at the closed position.

15. The system according to claim 2, further comprising:
a structure that surrounds the printing apparatus,
wherein the structure includes a cover arranged so as to be displaceable between a closed position where the cover covers the upper part of a carriage and an open position where the cover is placed at a position higher than the closed position,
the lifting unit and the guide unit are arranged on the inner side of the cover, and
the printing system comprises
a linking mechanism configured to cause the cover to move parallelly to the closed position and the open position,
a first lock member configured to restrict an orientation of the cover and an orientation of the linking mechanism at the open position,
a second lock member configured to restrict the position of the lifting unit in the horizontal direction to a predetermined position,
a third lock member detachably attached to the expanding and contracting unit and configured to restrict the expanding and contracting unit to a contracted state, and
a release mechanism configured to operate in synchronization with attachment of the third lock member and release the restriction placed by the first lock member, and
in a case in which the third lock member is attached to the expanding and contracting unit in state in which the lifting unit is positioned at the predetermined position, the release mechanism is configured to release the restriction of the first lock member.

16. The system according to claim 15, wherein in one of a state in which the lifting unit is not positioned at the predetermined state and a case in which the third lock member is removed from the expanding and contracting unit, the release mechanism does not release the restriction of the first lock member.

17. The system according to claim 16, wherein in one of the state in which the lifting unit is not positioned at the predetermined position and a case in which the third lock member is removed from the expanding and contracting unit, the cover cannot be displaced to the closed position by the restriction by the first lock member.

18. A work support apparatus that supports a replacement operation of a printhead in a printing apparatus that includes the printhead which discharges ink and a carriage supporting the printhead, comprising:
a lifting unit configured to lift the printhead from the carriage; and
a guide unit configured to guide the lifting unit to move in a horizontal direction.

19. A method of replacing a printhead in a printing apparatus that includes the printhead which discharges ink and a carriage supporting the printhead, the method comprising:
lifting the printhead from the carriage by a lifting unit; and
moving the printhead together with the lifting unit in a horizontal direction.
